(19) United States
(12) Patent Application Publication
(10) Pub. No.: US 2016/0362307 A1
(43) Pub. Date: Dec. 15, 2016

(54) CONTAINERIZED SYSTEM AND METHOD FOR SPRAY EVAPORATION OF WATER

(71) Applicant: Energy Water Solutions, LLC, The Woodlands, TX (US)

(72) Inventors: Stephen M. Shiner, The Woodlands, TX (US); Chuck Hanebuth, The Woodlands, TX (US)

(73) Assignee: Energy Water Solutions, LLC, The Woodlands, TX (US)

(21) Appl. No.: 15/177,519

(22) Filed: Jun. 9, 2016

Related U.S. Application Data
(60) Provisional application No. 62/173,509, filed on Jun. 10, 2015.

(51) Int. Cl. C02F 1/12; B01D 1/00; B01D 1/30; C02F 5/08; C02F 1/04; C02F 1/50; C02F 1/00; C02F 1/66; B01D 1/20; B01D 1/14

(52) U.S. Cl. CPC C02F 1/12; B01D 1/20; B01D 1/0082; B01D 1/305; B01D 1/14; C02F 1/048; C02F 1/042; C02F 1/50; C02F 1/008; C02F 1/66; C02F 5/08; C02F 2209/02; C02F 2209/06; C02F 2209/05; C02F 2209/38; C02F 2209/40; C02F 2303/04; C02F 2209/006

(57) ABSTRACT

A system for spray evaporating water comprising: a wastewater inlet; a pump, where an outlet of the wastewater inlet is fluidly connected to an inlet of the pump and wherein an outlet of the pump is fluidly connected to an inlet of a manifold; a spray nozzle, wherein an outlet of the manifold is fluidly connected to an inlet of the spray nozzle; a container, wherein an upper portion of the container is enclosed with a demister element and wherein the outlet of the spray nozzle discharges into the container; and a discharge outlet, wherein a bottom of the container is fluidly connected to the discharge outlet. A method of spray evaporating water is also disclosed.

### PRIOR RELATED APPLICATIONS

This application claims benefit of U.S. Provisional Patent Application Ser. No. 62/173,509, filed on Jun. 10, 2015, entitled “Containerized System and Method for Spray Evaporation of Water.”

### FEDERALLY SPONSORED RESEARCH STATEMENT

Not Applicable (N/A)

### REFERENCE TO MICROFICHE APPENDIX

N/A

### FIELD OF INVENTION

The invention relates generally to spray evaporation of water and, in particular, to a containerized system and method for spray evaporation of water by controlling pump pressure and/or water droplet size sprayed within a closed container by optimizing water volumetric flow and droplet size sprayed within the container.

### BACKGROUND OF THE INVENTION

Current methods for evaporation of undesired water (e.g., landfill leachate, produced water, mining wastewater, and wastewater) typically involve large surface area ponds, floating or land-based atomizing sprayers which spray back into a pond, or multi-stage flash evaporation (MSF). These methods have numerous problems. The large surface area solar-evaporation or spray ponds are slow to remove water. The floating or land-based sprayers improve the efficiency of the ponds but permit water droplets and aerosolized dissolved solids (e.g., salts) to be carried by the wind to contaminate other areas. MSF is a complex energy intensive process with high resultant operating costs. The alternative to not evaporating the water on or near the point of generation is removal via vacuum truck. The vacuum trucks remove water from the ponds but require disposal or treatment of the undesired water elsewhere. This can be quite expensive.

Therefore, there is a need for a containerized system and method for spray evaporation of undesired water to speed removal of the water, to contain the water droplets during evaporation and to reduce the cost of water disposal.

### SUMMARY OF THE INVENTION

The invention relates generally to spray evaporation of water and, in particular, to a containerized system and method for efficient spray evaporation of water by controlling pump pressure and/or water droplet size sprayed within a closed container and by optimizing water volumetric flow and droplet size sprayed within the container

The invention permits evaporation of large volumes of undesired water within a containerized, mobile system, which eliminates requirements for large evaporation ponds or vacuum truck disposal. More specifically, the invention maximizes the evaporation rate of undesired water by reducing water droplet size sprayed within a closed container and by optimizing water droplet size and volume sprayed within the container. The evaporated water exits the container as water vapor through a mist arresting system, leaving behind un-evaporated water droplets and dissolved minerals to collect in the sump (bottom) of the container. The condensed water is recirculated through the system and, once sufficiently concentrated, the concentrated water is diverted to external waste disposal storage.

A system for spray evaporating water comprising a wastewater inlet; a pump, where an outlet of the wastewater inlet is fluidly connected to an inlet of the pump and wherein an outlet of the pump is fluidly connected to an inlet of a manifold; a spray nozzle, wherein an outlet of the manifold is fluidly connected to an inlet of the spray nozzle; a container, wherein upper and side portions of the container are enclosed with a demister element and wherein the outlet of the spray nozzle discharges into the container; and a discharge outlet, wherein a bottom of the container is fluidly connected to the discharge outlet.

In an embodiment, the pump produces a water flow rate from about 50 gallons per minute (GPM) to about 800 GPM (and any range or value there between). In an embodiment, the pump produces a water flow rate from about 15 GPM to about 100 GPM.

A system for spray evaporating water comprising a wastewater inlet comprising wastewater; a first valve, wherein an outlet of the wastewater inlet is fluidly connected to an inlet of the first valve; a first pump, wherein an outlet of the first valve is fluidly connected to an inlet of the first pump; a container, wherein upper and side portions of the container are enclosed with a demister element and wherein the demister element retains un-evaporated water inside the container; a spray nozzle, wherein an outlet of the first pump is fluidly connected to a first inlet of a manifold, wherein an outlet of the manifold is fluidly connected to an inlet of the spray nozzle, and wherein an outlet of the spray nozzle discharges into the container; a second pump, wherein an outlet of the sump is fluidly connected to an inlet of the second pump; a second valve; wherein an outlet of the second pump is fluidly connected to a second inlet of a manifold and wherein a first outlet of the manifold is fluidly connected to the inlet of the spray nozzle; and a third valve, wherein a second outlet of the manifold is fluidly connected to an inlet of the third valve and wherein an outlet of the third valve is fluidly connected to a discharge outlet.

In an embodiment, the system further comprises an air blower, wherein air flow from the air blower disperses water droplets from the spray nozzle. In an embodiment, the air blower is disposed through a wall of the container such that air flow from the air blower is counter to water droplets from the spray nozzle. In an embodiment, the air blower is disposed through a wall of the container such that air flow from the air blower is crossways to water droplets from the spray nozzle. In an embodiment, the air blower produces an air flow rate from about 60,000 cubic feet per minute (CFM) to about 150,000 CFM (and any range or value there between).

In an embodiment, the system further comprises an air heater, wherein an air flow outlet of the air heater is fluidly connected to an air flow inlet of the air blower.

In an embodiment, the spray system comprises a spray manifold, wherein the outlet of the pump is fluidly connect to an inlet of the spray manifold; and a spray nozzle, wherein an inlet of the spray nozzle is connected to an outlet of the spray manifold, and wherein an outlet of the spray nozzle discharges into the container. In an embodiment, the spray nozzle is selected from the group consisting of plain-orifice nozzles, shaped-orifice nozzles, surface impingement spray nozzles, spiral spray nozzles, and pressure swirl spray nozzles. In an embodiment, the spray nozzle produces water droplet sizes from about 50 μm to about 1,000 μm (and any range or value there between).

In an embodiment, the system further comprises a programmable logic controller (PLC) or other computing device, wherein the PLC or other computing device controls the air flow rate from the air blower and the water droplet size from the spray nozzle.

In an embodiment, the system further comprises an acid conditioning system, wherein the acid conditioning system adds an acid solution to the wastewater.

In an embodiment, the system further comprises a bactericide conditioning system, wherein the bactericide conditioning system adds bactericide to the wastewater.

In an embodiment, the system further comprises a scale inhibition conditioning system, wherein the scale inhibition conditioning system adds scale inhibitor to the wastewater.

In an embodiment, the system further comprises a defoamer system, wherein the defoamer system adds defoamer to the wastewater.

In an embodiment, the first pump produces a water flow rate from about 50 gallons per minute (GPM) to about 100 GPM (and any range or value there between).

In an embodiment, the second pump produces a water flow rate from about 500 GPM to about 800 GPM (and any range or value there between).

In an embodiment, the demister element retains un-evaporated water inside the container.

A method for spray evaporating water comprises selecting predetermined parameters for a system for spray evaporating water; drawing wastewater into the system from an external water source using a pump; diverting wastewater to a spray nozzle; spraying the wastewater through the spray nozzle to create water droplets; dispersing the water droplets into a container of the system; collecting condensed water in the sump of the container; recycling the condensed water from the sump of the container, and diverting concentrated waste to a waste outlet.

In an embodiment, the method further comprises monitoring conductivity of condensed water using a conductivity meter.

In an embodiment, the predetermined parameters comprise air flow rate, air heating rate, maximum conductivity, and water flow rate, and wherein the concentrated water is discharged to the waste outlet when conductivity of the condensed water reaches the maximum conductivity.

In an embodiment, the air flow rate is from about 60,000 CFM to about 150,000 CFM (and any range or value there between).

In an embodiment, the pump produces a water flow rate from about 50 GPM to about 800 GPM (and any range or value there between). In an embodiment, the pump produces a water flow rate from about 15 GPM to about 100 GPM.

In an embodiment, the water droplet size is from 50 μm to about 1,000 μm (and any range or value there between).

In an embodiment, the method further comprises monitoring ambient air temperature using a temperature sensor, wherein the predetermined parameters further comprise minimum air temperature. In an embodiment, the system is shut down when the ambient air temperature reaches the minimum air temperature.

In an embodiment, the method further comprises monitoring the pH of the condensed water using a pH meter and adding acid solution to the condensed water to maintain the pH at about 6.5 or below, if required, based on waste water quality.

In an embodiment, the method further comprises adding bactericide to the condensed water.

In an embodiment, the method further comprises adding scale inhibitor to the condensed water. In an embodiment, the method further comprising monitoring the pH of the condensed water using a pH meter and adding acid solution to the condensed water to maintain the pH at about 6.5 or below, if required, based on waste water quality.

In an embodiment, the method further comprises adding defoamer to the condensed water.

In an embodiment, the method further comprises using a programmable logic controller or other computing device to control the system.

These and other objects, features and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

For a further understanding of the nature and objects of the present invention, reference should be made to the following detailed disclosure, taken in conjunction with the accompanying drawings, in which like parts are given like reference numerals, and wherein:

FIG. 1A illustrates a schematic of an exemplary system for spray evaporation of water according to an embodiment of the present invention;

FIG. 1B illustrates a schematic of a front view of the exemplary system of FIG. 1A;

FIG. 1C illustrates a schematic of a rear view of the exemplary system of FIG. 1A;

FIG. 2A illustrates a drawing of a front view of an exemplary system for spray evaporation of water according to an embodiment of the present invention;

FIG. 2B illustrates a drawing of a front, left perspective view of the exemplary system in FIG. 2A;

FIG. 2C illustrates a drawing of a front, right perspective view of the exemplary system in FIG. 2A;

FIG. 2D illustrates a drawing of a front, left perspective view of an exemplary system for spray evaporation of water according to an embodiment of the present invention;

FIG. 2E illustrates a drawing of a left side view of an exemplary system for spray evaporation of water according to an embodiment of the present invention;

FIG. 2F illustrates a drawing of a rear view of an exemplary system for spray evaporation of water according to an embodiment of the present invention;

FIG. 3 illustrates a drawing of a front, left perspective view of an exemplary system for spray evaporation of water according to an embodiment of the present invention, showing an internal spray system;

FIG. 4A illustrates a schematic of an exemplary system for spray evaporation of water according to an embodiment of the present invention;

FIG. 4B illustrates a schematic of a front portion of the exemplary system of FIG. 4A;

FIG. 4C illustrates a schematic of a rear portion of the exemplary system of FIG. 4A;

FIG. 5A illustrates a drawing of a front, left perspective view of an exemplary system for spray evaporation of water according to an embodiment of the present invention, showing inlet, recycle and discharge piping;

FIG. 5B illustrates a drawing of a front, left perspective view of an exemplary system for spray evaporation of water according to an embodiment of the present invention, showing hydraulic air blowers with hydraulic drive system and reservoir;

FIG. 5C illustrates a drawing of a front, left perspective view of an exemplary system for spray evaporation of water according to an embodiment of the present invention, showing an air ducting plenum to force blower inlet air through heaters;

FIG. 5D illustrates a drawing of an upper, left perspective view of an exemplary system for spray evaporation of water according to an embodiment of the present invention, showing optional catwalks and ladders to access demister system;

FIG. 6 illustrates a block diagram for a programmable logic controller (PLC) or computing device for an exemplary system for spray evaporation of water according to an embodiment of the present invention;

FIG. 7A illustrates a method of using an exemplary system for spray evaporation of water according to an embodiment of the present invention;

FIG. 7B illustrates additional, optional steps for the method of FIG. 7A;

FIG. 8A illustrates a method of using an exemplary system for spray evaporation of water according to an embodiment of the present invention;

FIG. 8B illustrates additional, optional steps for the method of FIG. 8A; and

FIG. 9 illustrates a flow diagram for a PLC or computing device for an exemplary system for spray evaporation of water according to an embodiment of the present invention.

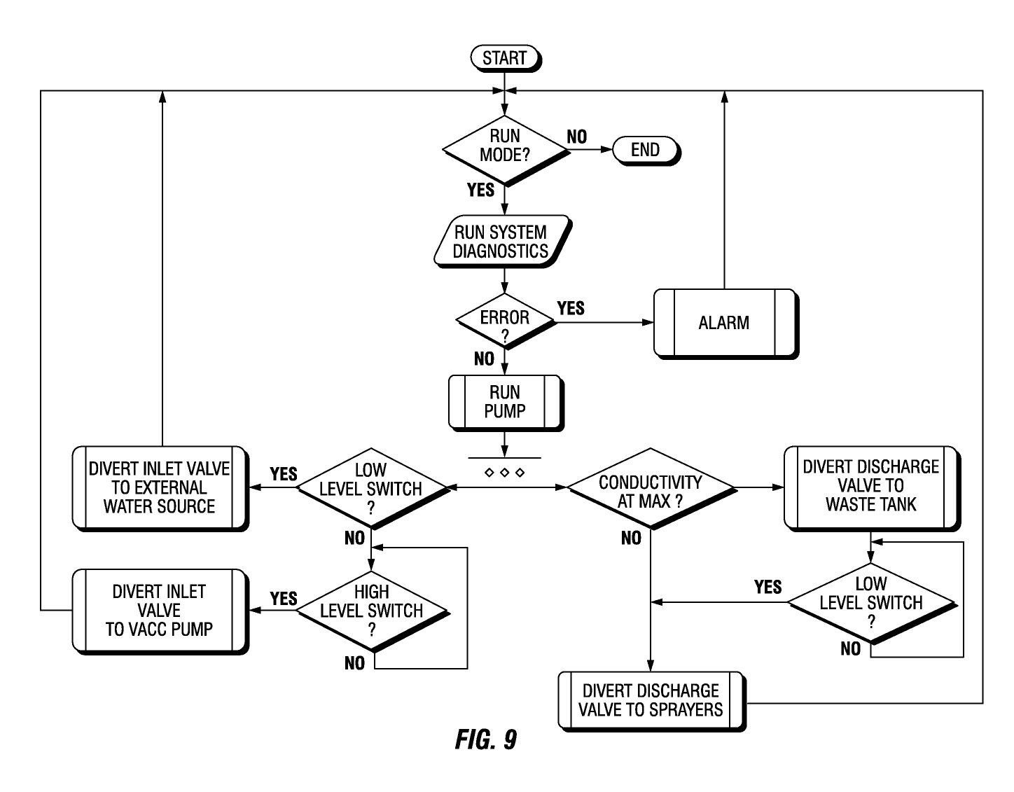

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

### System for Spray Evaporation of Water

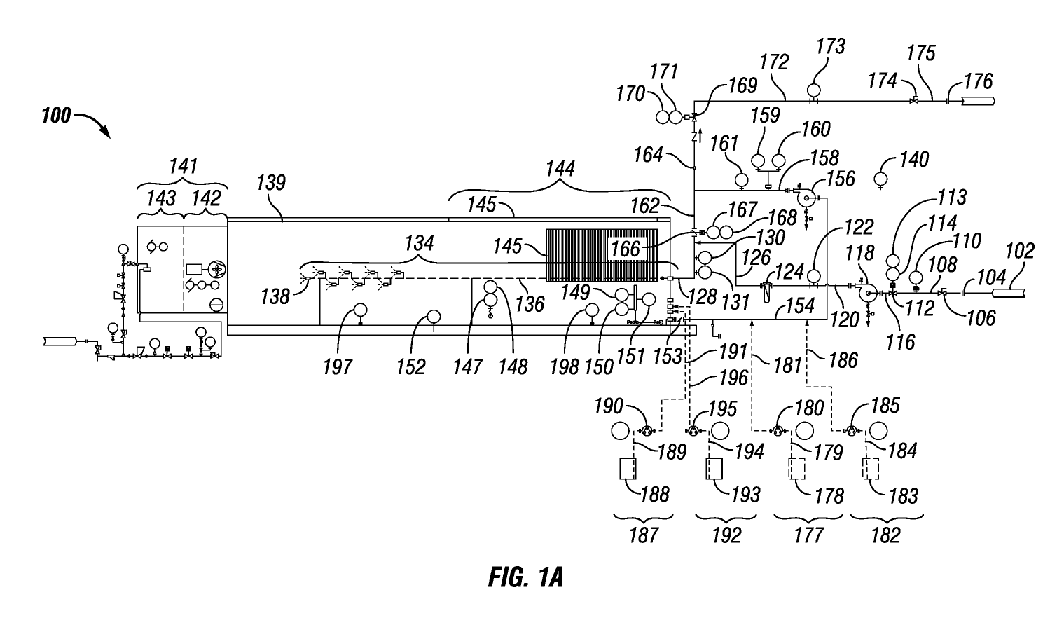

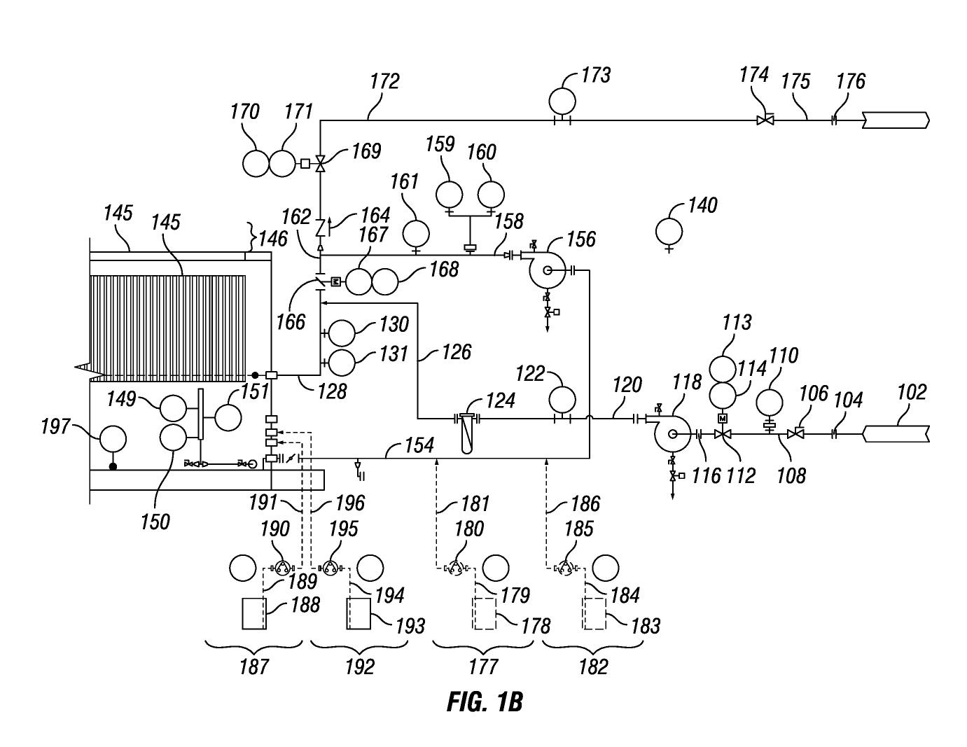

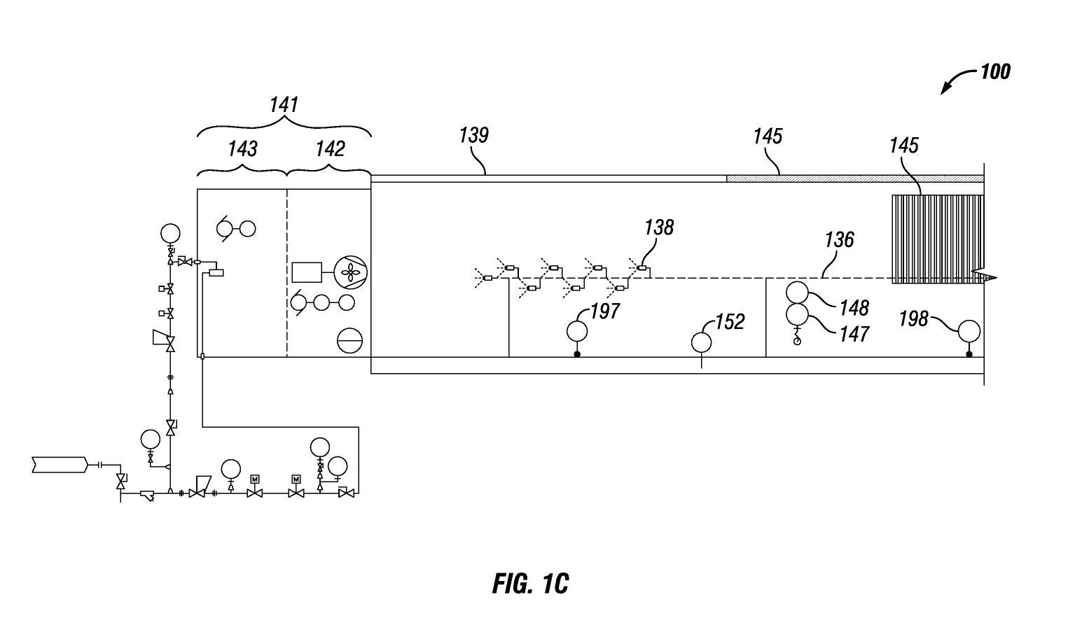

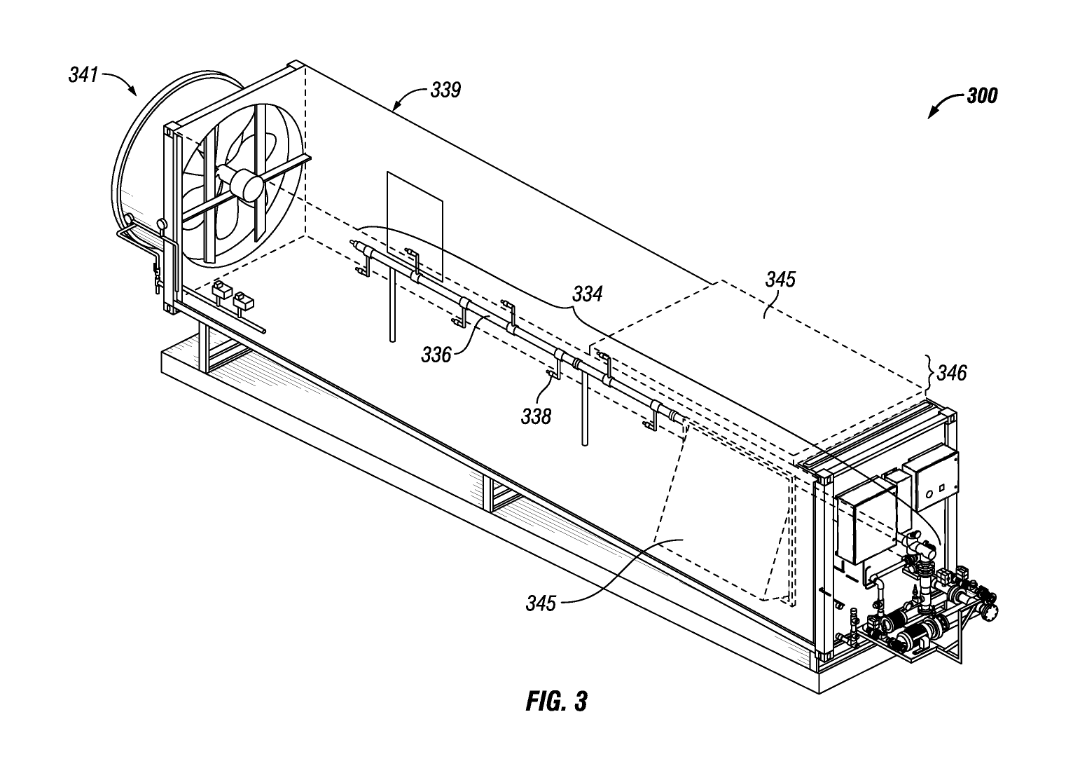

A schematic of an exemplary alternative system 100, 200, 300 for spray evaporation of water according to an embodiment of the present invention is shown in FIGS. 1A-3. The system 100, 200 comprises a wastewater inlet 104, 204, a first (feed) pump 118, 218, a first manifold 128, 228, a spray system 136, 236, a container 139, 239, a demister element 145, 245, an air blower 142, 242 and a discharge outlet 176, 276.

In an embodiment, the system 100, 200, 300 is capable of evaporating between about 2,000 to about 10,000 gallons of wastewater per day (see FIGS. 1A-3). If a higher throughput is desired, a plurality of the system 100, 200, 300 may be used in parallel to treat the wastewater.

### Inlet System

In an embodiment, the system 100, 200 may further comprise a first (feed) shut-off valve 106, 206 and/or a first (feed) valve 112, 212. The wastewater inlet 104 may be connected to an inlet of a first shut-off valve 106 via a pipe 108. An outlet of the first shut-off valve 106 may be connected to an inlet of the pump 118 via a pipe 116

The wastewater inlet 104 may be any suitable wastewater inlet that can handle up to about 40 psi. Suitable wastewater inlets include, but are not limited to, flange connections, cam-lock fittings and hammer unions. In an embodiment, the wastewater inlet 104 is a flange connection (see FIGS. 1A-3). The wastewater inlet 104 permits connection to an external wastewater source. The water inlet 104 may be connected to the external wastewater source via a hose, pipe or other means customary in the art.

In an embodiment, the system 100, 200 may further comprise a first (feed) valve 112, 212. The first (feed) valve 112 may be any suitable switching valve. Suitable first (feed) valves 112 include, but are not limited to, ball valves. For example, a suitable first (feed) valve 112 is available from GF Piping Systems. In an embodiment, the first (feed) valve 112 may be a GF Piping System Type 546 Electric Actuated Ball Valve from GF Piping Systems. In an embodiment, the first (feed) valve 112 may be automatic or manual. In an embodiment, the first (feed) valve 112 may be electric or pneumatic actuation. In an embodiment, the first (feed) valve 112 may be normally CLOSED.

In an embodiment, the system 100 may further comprise a first limit switch 113 and a second limit switch 114. In an embodiment, the first limit switch 113 confirms that the first (feed) valve 112 is OPEN; and the second limit switch 114 confirms that the first (feed) valve 112 is CLOSED.

In an embodiment, the first (feed) valve 112 may have 2-inch connections. In an embodiment, the system 100, 200 may further comprise a first (feed) shut-off valve 106, 206. The first (feed) shut-off valve 106 may be any suitable shut-off valve. Suitable first (feed) shut-off valves 106 include, but are not limited to, ball valves and butterfly valves. For example, a suitable first (feed) shut-off valve 106 is available from GF Piping Systems. In an embodiment, the first (feed) shut-off valve 106 may be a GF Piping Systems Type 546 Ball Valve from GF Piping Systems. In an embodiment, the first (feed) shut-off valve 106 may be automatic or manual. In an embodiment, the first (feed) shut-off valve 106 may be normally CLOSED.

In an embodiment, the first (feed) shut-off valve 106 may have 2-inch connections.

The first (feed) shut-off valve 106 may be made of any suitable corrosion-resistant material. The first (feed) shut-off valve 106 may be made of any suitable corrosion-resistant metals or plastics. Suitable metals include, but are not limited to, plastic-coated carbon steel, stainless steel, Hastelloy® alloy, Monel® alloy and combinations thereof; and suitable plastic include, but are not limited to, polyvinylchloride (PVC) polymers, chlorinated polyvinyl chloride (CPVC) polymers, fiberglass reinforced plastic (FRP), Kynar® polyvinylidene fluoride (PVDF) polymers, polyethylene polymers, polypropylene polymers, Teflon® perfluoroalkoxy (PFA) polymers, Teflon® polytetrafluroethylene (PTFE) polymers, and combinations thereof. In an embodiment, the first (feed) shut-off valve 106 (wetted components) may be made of polyvinyl chloride (PVC) and ethylene propylene diene monomer (EPDM) rubber.

An outlet of the first (feed) shut-off valve 106 may be connected to an inlet of the first (feed) valve 112 via pipe 108. An outlet of the first (feed) valve 112 may be connected to an inlet of a first (feed) pump 118 via a pipe 116.

The pipe 108, 116 may be made of any suitable corrosion-resistant pipe. The pipe 108, 116 may be any suitable corrosion-resistant metals or plastics. Suitable metals include, but are not limited to, plastic-coated carbon steel, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the pipe 108, 116 may be made of plastic-coated carbon steel. In an embodiment, the pipe 108, 116 may be made of Plasite 7159 HAR-coated carbon steel. In an embodiment, the pipe 108, 116 may be made of 316 stainless steel.

In an embodiment, the pipe 108, 116 may be 2-inch pipe.

The first (feed) pump 118 may be any suitable pump. Suitable first (feed) pumps 118 include, but are not limited to, centrifugal pumps. For example, a suitable first (feed) pump 118 is available from MP Pumps Inc. In an embodiment, the first (feed) pump 118 may be a FLOMAX® 8 Self-Priming Centrifugal Pump from MP Pumps Inc. In an embodiment, the first (feed) pump 118 may be about 3 to about 5 HP centrifugal pump.

In an embodiment, the first (feed) pump 118 has 2-inch connections.

The first (feed) pump 118 may be made of any suitable corrosion-resistant material. The first (feed) pump 118 may be made of any suitable corrosion-resistant metals or plastics. Suitable metals include, but are not limited to, cast iron, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. For example, the first (feed) pump 118 (wetted components) may be made of stainless steel, super-duplex stainless steel, AL-6XN alloy, Ni—Al—Brz alloy, Hastelloy® alloy, Monel® alloy or FRD. In an embodiment, the first (feed) pump 118, including internal wetted components, was made of 316 stainless steel. In an embodiment, the first (feed) pump 118 may be made of cast iron if a shorter service life is acceptable.

In an embodiment, the system 100, 200 may further comprise a basket strainer 124, 224 and an optional pressure sensor (not shown). An inlet of the basket strainer 124 may be fluidly connected to an outlet of pipe 120, and an outlet of the basket strainer 124 may be fluidly connected to an inlet of pipe 126. The basket strainer 124 retains debris in the water feed to prevent clogging of the spray nozzles 138. An obstruction in the basket strainer 124 may be detected via a decreased feed rate at the first flow meter 122.

The basket strainer 124 may be any suitable basket strainer, and may contain a reusable or disposable mesh or synthetic fiber bag. A suitable basket strainer 124 includes, but is not limited to, ⅛-inch perforated baskets, contained within a simplex or duplex housing. For example a suitable basket strainer 124 is available from Hayward or Rosedale. In an embodiment, the basket strainer 124 may be a ⅛-inch perforated basket from Hayward or Rosedale.

The basket strainer 124 may be made of any suitable corrosion-resistant material. The basket strainer 124 may be made of any suitable corrosion-resistant metals or plastics. The basket strainer 124 may be any suitable metal or plastic basket strainer. Suitable metals include, but are not limited to, stainless steel, Hastelloy® alloy, Monel® alloy and combinations thereof; and suitable plastics include, but are not limited to, chlorinated polyvinyl chloride (CPVC) polymers, Kynar® polyvinylidene fluoride (PVDF) polymers, polyvinyl chloride (PVC) polymers, Teflon® perfluoroalkoxy (PFA) polymers, Teflon® polytetrafluroethylene (PTFE) polymers, and combinations thereof. In an embodiment, the basket strainer 124 (basket) may be made of 316 stainless steel.

In an embodiment, the optional pressure sensor (not shown) may be fluidly connected to either the pipe 120 or the inlet of the basket strainer 124. An obstruction in the basket strainer 124 may also be detected via an increase in pressure at the optional pressure sensor (not shown).

The optional pressure sensor (not shown) may be any suitable pressure sensor. For example, a suitable pressure sensor is available from Rosemount, Inc. In an embodiment, the pressure sensor may be a Rosemount 2088 Absolute and Gage Pressure Transmitter from Rosemount, Inc.

An outlet of the first (feed) pump 118 may be connected to an inlet of a basket strainer 124 via pipe 120. An outlet of the basket strainer 124 may be connected to a first inlet to a first manifold 128 via a pipe 126.

The pipe 120, 126, 128 may be made of any suitable corrosion-resistant pipe. The pipe 108, 126, 128 may be any suitable metal or plastic pipe. Suitable metals include but are not limited to, plastic-coated carbon steel, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the pipe 120, 126, 128 may be made of plastic-coated carbon steel. In an embodiment, the pipe 120, 126, 128 may be made of Plasite 7159 HAR-coated carbon steel. In an embodiment, the pipe 120, 126, 128 may be made of 316 stainless steel.

In an embodiment, the pipe 120, 126, 128 may be 2-inch pipe.

An outlet of the first manifold 128 may be connected to an inlet of a spray system 134. In an embodiment, the spray system 134 comprises a spray manifold 136 and a spray nozzle 138, wherein the spray nozzle 138 may be connected to an outlet of the spray manifold 136. In an embodiment, the spray system 134 is disposed inside the container 139.

An outlet of the spray nozzle 138 discharges water droplets inside the container 139. An upper portion or top side of the container 139 is enclosed with the demister element 145 to retain the water droplets inside the container 139. In an embodiment, a side portion of the container 139 is also enclosed with the demister element 145 to retain the water droplets inside the container 139. The demister element 145 is secured to and supported by the container 139 in a manner customary in the art.

At least some of the water droplets evaporate to form water vapor. The water vapor passes through the demister element 145 and out the evaporated water outlet 146. Any un-evaporated water is retained by the demister element 145 and falls to a sump (bottom) of the container 139.

In an embodiment, the spray system 134 comprises a spray manifold 136 and a plurality of spray nozzles 138′, 138″ wherein each of the plurality of spray nozzles 138′, 138″ may be connected to an outlet of the spray manifold 136. Outlets of the plurality of spray nozzles 138′, 138″ discharge water droplets inside the container 139. An upper portion or top side of the container 139 is enclosed with the plurality of demister elements 145′, 145″ to retain the water droplets inside the container 139. In an embodiment, a side portion of the container 139 is also enclosed with the demister element 145 to retain the water droplets inside the container 139. The plurality of demister elements 145′, 145″ are secured to and supported by the container 139 in a manner customary in the art.

At least some of the water droplets evaporate to form water vapor. The water vapor passes through pores (tortuous paths) in the plurality of demister elements 145′, 145″ and out the evaporated water outlet 146. Any un-evaporated water is retained by the plurality of demister elements 145′, 145″ and falls to the sump (bottom) of the container 139.

The evaporated water outlet 146 comprises a plurality of outlet pores (not shown) in the plurality of demister elements 145′, 145″.

The spray nozzle 138 may be any suitable spray nozzle. Suitable spray nozzles 138 include, but are not limited to, plain-orifice nozzles, shaped-orifice nozzles, surface impingement spray nozzles, spiral spray nozzles, and pressure swirl spray nozzles. For example, a suitable spray nozzle 138 is available from BETE Fog Nozzle, Inc. In an embodiment, the spray nozzle 138 may be a Type TF spiral spray nozzle from BETE Fog Nozzle, Inc. In an embodiment, the spiral spray nozzle 138 may be 30, 60, 90, 120, 150 and 170 degrees. In an embodiment, the spiral spray nozzle may be capable from about 50 gallons per minute (GPM) to about 70 GPM per spray head (and any range or value there between). In an embodiment, the rotary atomizer produces water droplet sizes from about 50 μm to about 1,000 μm. In an embodiment, the spray nozzles 138 are positioned inside the container.

The spray nozzle 138 may be made of any suitable corrosion-resistant material. The spray nozzle 138 may be made of any suitable corrosion-resistant metals or plastics. Suitable metals, include, but are not limited to, brass, Cobalt Alloy 6, reaction bonded silicon carbide (RBSC) ceramic, stainless steel, Hastelloy® alloy, Monel® alloy, and combinations thereof; and suitable plastics, include, but are not limited to, polypropylene, polytetrafluroethylene (PTFE), polyvinyl chloride (PVC), and combinations thereof. In an embodiment, the spray nozzle 138 (spray head) may be made of PVC. In an embodiment, the spray nozzle 138 (wetted component) may be made of PVC. In an embodiment, the spray nozzle 138 (wetted component) may be made of Cobalt Alloy 6 and/or RBSC ceramic.

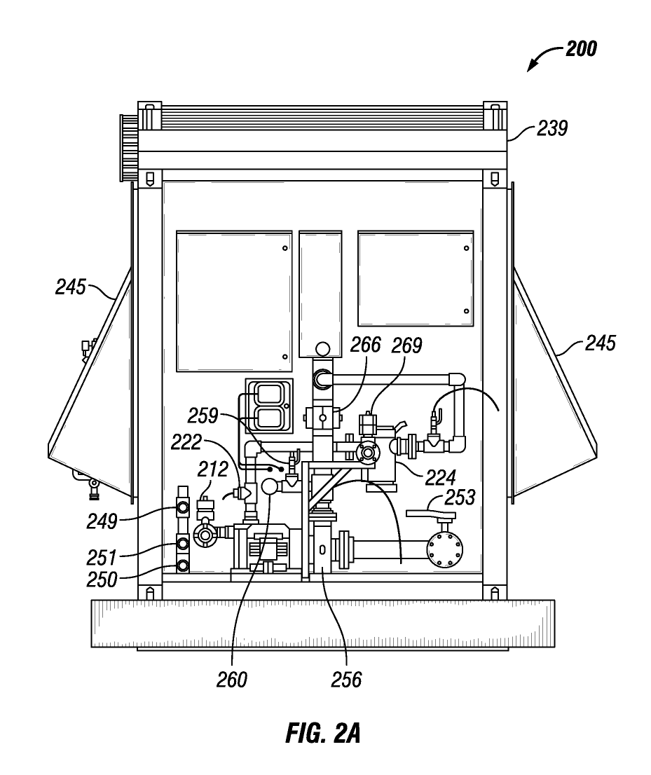

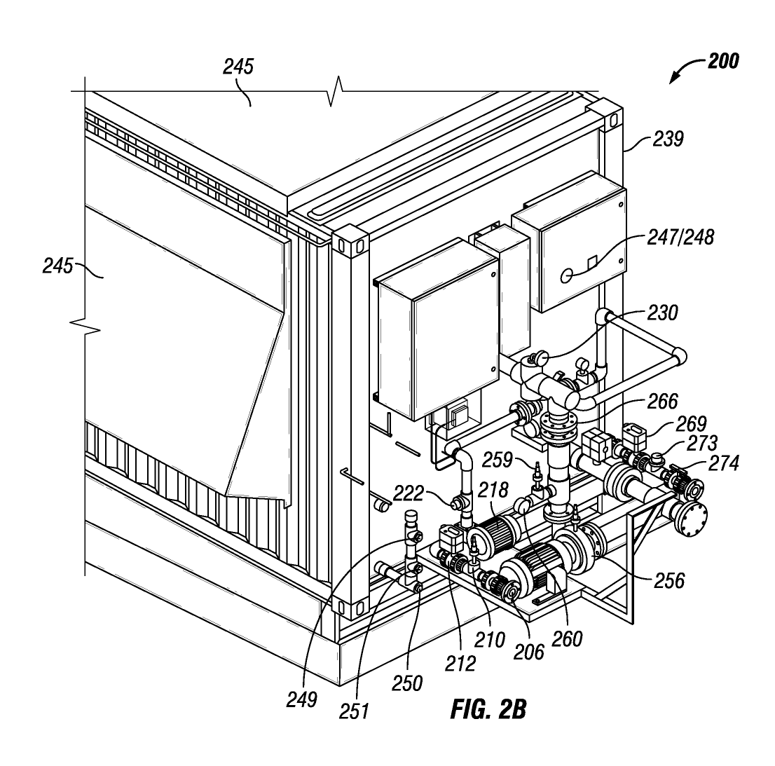

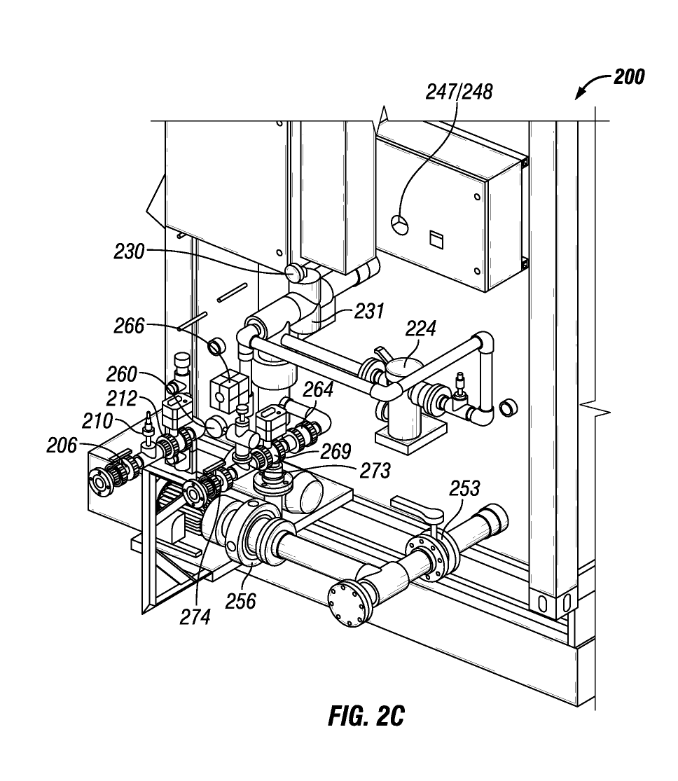

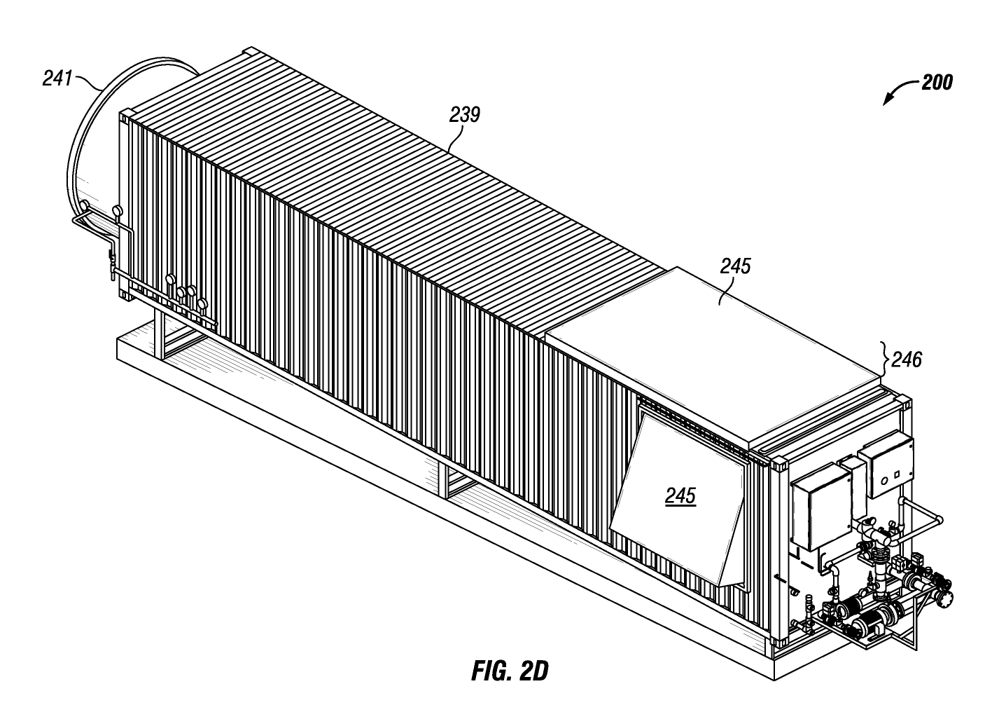

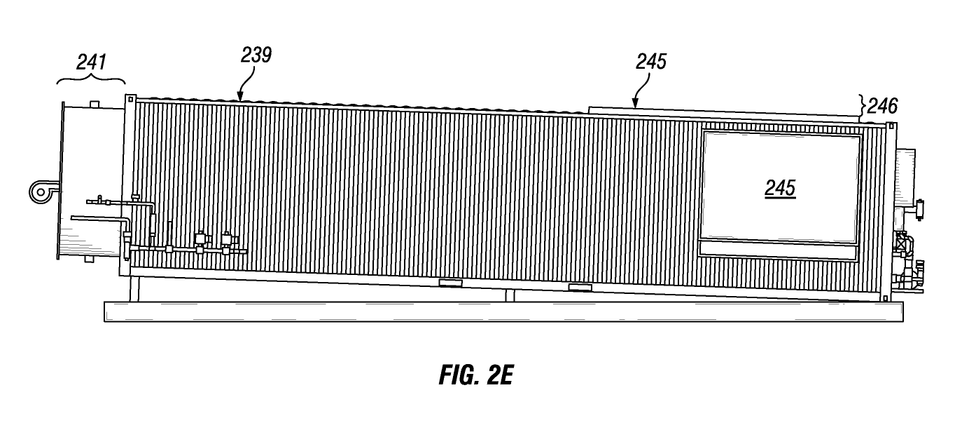

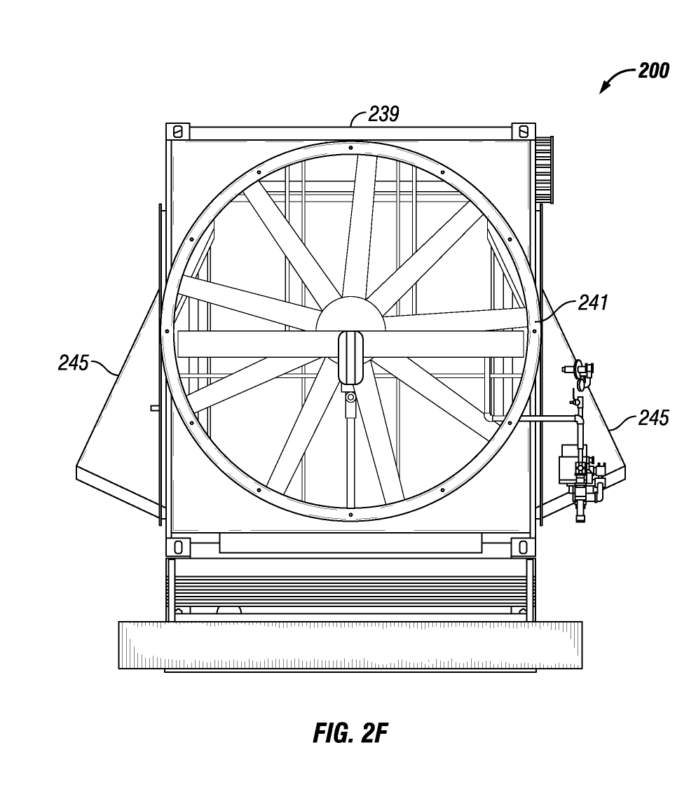

The container 139 may be any suitable container. The container 139 may be mobile or it may be stationary. Suitable containers 139 include, but are not limited to, intermodal containers and frac tanks (see FIGS. 2A-2F). For example, a suitable frac tank container 139 is available from PCI Manufacturing, LLC. In an embodiment, the container 139 may be a 500BBL, V-bottom frac tank from PCI Manufacturing, LLC. For example, a suitable intermodal container 139 is available from West Gulf Container Company. In an embodiment, the container 139 may be a 40-foot high bay container from West Gulf Container Company.

Alternatively, the container 139 may be made of any suitable corrosion-resistant material. The container 139 may be made of coated metal, corrosion-resistant metals or plastics. Suitable coated metals include, but are not limited to, epoxy-coated carbon steels, plastic-coated carbon steels, and combinations thereof; suitable corrosion-resistant metals include, but are not limited to, stainless steel, Hastelloy® alloy, Monel® alloy, and combinations thereof; and suitable plastics include, but are not limited to, polyethylene, polypropylene, polyvinyl chloride (PVC), and combinations thereof. In an embodiment, the container 139 may be made of epoxy-coated carbon steel and/or plastic-coated carbon steel. In an embodiment, the container 139 may be made of Plasite 7159 HAR-coated carbon steel.

The container 139 may be any suitable shape. Suitable shapes include, but are not limited to, cylindrical, cubic, cuboid, prism, pyramid, spherical and combinations thereof. In an embodiment, the container 139 may be approximately a cuboid shape.

The demister element 145 may be any suitable demister element. Suitable demister elements 145 include, but are not limited to, crossflow cellular drift eliminators (see FIGS. 2A-2F). For example, a suitable demister element 145 is available from Brentwood Industries, Inc. In an embodiment, the demister element 145 may be an Accu-Pac® Crossflow Cellular Drift Eliminator from Brentwood Industries, Inc.

Alternatively, the demister element 145 may be made of any suitable corrosion-resistant material. The demister element 145 may be any suitable corrosion-resistant metals or plastics. The demister element 145 may be made of metal or plastic mesh or baffled, torturous-path chevron-type plates. Suitable metal mesh includes, but is not limited to, stainless steel, Hastelloy® alloy, Monel® alloy and combinations thereof; suitable plastic mesh includes, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof; and suitable chevron-type plates include, but are not limited to, polyethylene, polypropylene, polyvinylchloride (PVC), stainless steel, Teflon® perfluoroalkoxy (PFA) polymers, Teflon® polytetrafluroethylene (PTFE) polymers. In an embodiment, the demister element 145 may be made of 316 stainless steel. In an embodiment, the demister element 145 may be made of PVC.

The demister element 145 may be any suitable shape to enclose an upper portion and/or a side portion of the container 139. Suitable shapes include, but are not limited to, cylindrical, cubic, cuboid, prism, pyramid, spherical, and portions and combinations thereof. In an embodiment, the demister element 145 (e.g., upper portion and/or side portion) may be a cuboid shape about 4-feet wide by about 8-feet long and about 4-inches to about 6-inches thick.

As shown in FIG. 1, the demister element 145 forms an upper portion and a side portion of the cuboid shape of the container 139. In an embodiment, the demister element 145 (e.g., upper portion) may be a cuboid shape about 8-feet wide by about 16-feet long and about 6-inches thick. In an embodiment, the demister element 145 (e.g., side portion) may be a cuboid shape about 6-feet wide by about 8-feet long and about 6-inches thick.

The evaporated water outlet 146 comprises a plurality of outlet pores (not shown) in the demister element 145.

In an embodiment, the system 100 may further comprise a first sacrificial anode 197 and a second sacrificial anode 198 for galvanic cathode (corrosion) protection of the container 139. The first sacrificial anode 197 and second sacrificial anode 198 may be disposed in the sump (bottom) of the container 139.

The first sacrificial anode 197 and second sacrificial anode 198 may be made of any suitable galvanic anode material. For example, suitable galvanic anode materials include, but are not limited to, aluminum, magnesium and zinc. In an embodiment, the first sacrificial anode 197 and second sacrificial anode 198 may be made of aluminum and/or zinc.

### Air Blower and Heater System

In an embodiment, the system 100, 200 may further comprise an air blower 142, 242. In an embodiment, air flow from the air blower 142 disperses the water droplets from the spray nozzle 138. In an embodiment, the air blower 142 is disposed through a wall of the container 139 such that air flow from the air blower 142 is counter to the water droplets from the spray nozzle 138.

In an embodiment, the air blower 142 is disposed through a wall of the container 139 such that air flow from the air blower 142 is crossways to the water droplets from the spray nozzle 138. In an embodiment, a wastewater to air ratio may range from about 550 gallons per minute (GPM)/about 150,000 cubic feet per minute (CFM) to about 800 GPM/60,000 CFM (and any range or value there between).

The air blower 142 may be any suitable axial blower. For example, a suitable air blower 142 is available from L.C. Eldridge Sales Co. In an embodiment, the air blower 142 may be a 95-inch Eldridge Model IC92S-3GD310-R3A fan from L.C. Eldridge Sales Co. In an embodiment, the air blower 142 may be a fixed or variable-speed air blower. In an embodiment, the air blower 142 may provide from about 60,000 CFM to about 150,000 CFM (and any range or value there between). In an embodiment, the air blower 142 may provide about 100,000 CFM.

In an embodiment, the system 100, 200 may further comprise an air blower and heater system 141, 241. For example, the air blower and heater system 141 may be disposed through a rear wall of the container 139 when the spray nozzles 138′, 138″ of the spray system 134 discharge toward the rear of the container 139.

In an embodiment, the air blower and heater system 141 comprises an air blower 142 and an air heater 143. In an embodiment, an air flow outlet of the air heater 143 is fluidly connected to an air flow inlet of the air blower 142.

The air heater 143 may be any suitable heater. For example, the air heater is available from Maxon Corporation. In an embodiment, the air heater 143 may be a Maxon APX Line Burner (natural gas burner) from Maxon Corporation. In an embodiment, the air heater 143 may provide an air heating rate from about 0 million BTU per hour to about 4 million BTU per hour (and any range or value there between).

In an embodiment, the air heater 143 may have one or more combustion air blower(s). In an embodiment, the combustion air blower may be about 1.5 horsepower (HP).

### Recycle System

In an embodiment, the system 100, 200 may further comprise a second (recycle) shut-off valve 153, 253, a second (recycle) pump 156, 256 and a second (recycle) valve 166, 266. An outlet of the sump (bottom) of the container 139 may be connected to an inlet of a second (recycle) pump 156 via pipe 154. An outlet of the second (recycle) pump 156 may be connected to an inlet of a second manifold 162 via a pipe 158. A first outlet of the second manifold 162 may be connected to a second (recycle) valve 166 discussed below.

In an embodiment, the system 100, 200 may further comprise a second (recycle) shut-off valve 153, 253. The second (recycle) shut-off valve 153 may be any suitable shut-off valve. Suitable second (recycle) shut-off valves 153 include, but are not limited to, ball valves and butterfly valves. For example, a suitable second (recycle) shut-off valve 153 is available from GF Piping Systems. In an embodiment, the second (recycle) shut-off valve 153 may be a GF Piping Systems PVC Wafer Style Butterfly Valve from GF Piping Systems. In an embodiment, the second (recycle) shut-off valve 153 may be automatic or manual. In an embodiment, the second (recycle) shut-off valve 153 may be normally CLOSED.

In an embodiment, the second (recycle) shut-off valve 153 has 4-inch connections.

The second (recycle) shut-off valve 153 may be made of any suitable corrosion-resistant material. The second (recycle) shut-off valve 153 may be made of any suitable corrosion-resistant metals or plastics. Suitable metals include, but are not limited to, plastic-coated carbon steel, stainless steel, Hastelloy® alloy, Monel® alloy and combinations thereof; and suitable plastics include, but are not limited to, ethylene propylene diene monomer (EPDM) rubber, polyvinylchloride (PVC) and combinations thereof. In an embodiment, the second (recycle) shut-off valve 153 (wetted components) may be made of polyvinyl chloride (PVC) and ethylene propylene diene monomer (EPDM) rubber.

In an embodiment, the system 100, 200 may further comprise a second (recycle) pump 156, 256. The second (recycle) pump 156 may be any suitable pump. Suitable second (recycle) pumps 156 include, but are not limited to, centrifugal pumps. For example, a suitable second (recycle) pump 156 is available from Ampco Pumps Company. In an embodiment, the second (recycle) pump 156 may be an Ampco Z-Series Centrifugal Pump from Ampco Pumps Company. In an embodiment, the second (recycle) pump 156 may be a 15 HP centrifugal pump.

In an embodiment, the second (recycle) pump 156 may have a 4-inch inlet (suction) connection and a 3-inch outlet (discharge) connection.

The second (recycle) pump 156 may be made of any suitable corrosion-resistant material. The second (recycle) pump 156 may be made of any suitable corrosion-resistant metals or plastics. Suitable metals include but are not limited to, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. For example, the second (recycle) pump 156, including internal wetted components, may be made of stainless steel, super-duplex stainless steel, AL-6XN alloy, Ni—Al—Brz alloy, Hastelloy® alloy, Monel® alloy or FRD. In an embodiment, the second (recycle) pump 156 (wetted components) may be made of Ni—Al-Brz alloy.

An outlet of the second (recycle) pump 156 may be connected to an inlet of a second manifold 162 via pipe 158.

In an embodiment, the system 100, 200 may further comprise a second (recycle) valve 166, 266. The second (recycle) valve 166 may be any suitable switching valve. Suitable second (recycle) valves 166 include, but are not limited to, ball and butterfly valves. For example, a suitable second (recycle) valve 166 is available from GF Piping Systems. In an embodiment, the second (recycle) valve 166 may be a GF Piping Systems Type 563 Electric Actuated Butterfly Valve from GF Piping Systems. In an embodiment, the second (recycle) valve 166 may be automatic or manual. In an embodiment, the second (recycle) valve 166 may be electric or pneumatic actuation. In an embodiment, the second (recycle) valve 166 may be normally CLOSED.

In an embodiment, the second (recycle) valve 166 has 4-inch connections.

In an embodiment, the system 100, 200 may further comprise a third limit switch 167, 267 and a fourth limit switch 168, 268. In an embodiment, the third limit switch 167 confirms that the second (recycle) valve 166 is CLOSED; and the fourth limit switch 168 confirms that the second (recycle) valve 166 is OPEN.

A first outlet to the second manifold 162 may be connected to a second inlet to the first manifold 128.

The pipe 128, 158, 162 may be made of any suitable corrosion-resistant pipe. The pipe 128, 158, 162 may be any suitable corrosion-resistant metals or plastics. Suitable metals include but are not limited to, plastic-coated carbon steel, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the pipe 128, 158, 162 may be made of plastic-coated carbon steel. In an embodiment, the pipe 128, 158, 162 may be made of Plasite 7159 HAR-coated carbon steel. In an embodiment, the pipe 128, 158, 162 may be made of 316 stainless steel.

In an embodiment, the pipe 128, 158, 162 may be 4-inch pipe.

### Discharge System

In an embodiment, the system 100, 200 may further comprise a check valve 164, 264 a third discharge valve 169, 269 and a third (discharge) shut-off valve 174, 274. A second outlet of the second manifold 162 may be connected to an inlet of a check valve 164 or an inlet of a third (discharge) valve 169.

In an embodiment, the system 100, 200 may further comprise a check valve 164, 264. The check valve 164 may be any suitable check valve. Suitable check valves 164 include, but are not limited to, one-way valves. A second outlet of the second manifold 162 may be connected to an inlet of a check valve 164; and an outlet of the check valve 164 may be connected to an inlet of a third (discharge) valve 169.

In an embodiment, the system 100, 200 may further comprise a third (discharge) valve 169, 269. The third (discharge) valve 169 may be any suitable switching valve. Suitable feed valves include, but are not limited to, ball valves. For example, a suitable third (discharge) valve 169 is available from GF Piping Systems. In an embodiment, the third (discharge) valve 169 may be a GF Piping Systems Type 546 Electric Actuated Ball Valve from GF Piping Systems. In an embodiment, the third (discharge) valve 169 may be automatic or manual. In an embodiment, the third (discharge) valve 169 may be electric or pneumatic actuation. In an embodiment, the third (discharge) valve 169 may be normally CLOSED.

In an embodiment, the third (discharge) valve 169 has 2-inch connections.

In an embodiment, the system 100, 200 may further comprise a fifth limit switch 170, 270 and a sixth limit switch 171, 271. In an embodiment, the fifth limit switch 170, 270 confirms that the third (discharge) valve 169 is OPEN; and the sixth limit switch 171, 271 confirms that the third (discharge) valve 169 is CLOSED.

A second outlet of the second manifold 162 may be connected to an inlet of a third (discharge) valve 169; and an outlet of the third (discharge) valve 169 may be connected to an inlet of a second (discharge) shut-off valve 174 via pipe 172.

In an embodiment, the system 100, 200 may further comprise a third (discharge) shut-off valve 174, 274. The third (discharge) shut-off valve 174 may be any suitable shut-off valve. Suitable third (discharge) shut-off valves 174 include, but are not limited to, ball valves and butterfly valves. For example, a suitable third (discharge) shut-off valve 174 is available from GF Piping Systems. In an embodiment, the third (discharge) shut-off valve 174 may be a GF Piping Systems Type 546 PVC Ball Valve from GF Piping Systems. In an embodiment, the third (discharge) shut-off valve 174 may be automatic or manual. In an embodiment, the third (discharge) shut-off valve 174 may be normally CLOSED.

In an embodiment, the third (discharge) shut-off valve 174 has 2-inch connections.

The third (discharge) shut-off valve 174 may be made of any suitable corrosion-resistant material. The third (discharge) shut-off valve 174 may be made of any suitable corrosion-resistant metals or plastics. Suitable metals include, but are not limited to, plastic-coated carbon steel, stainless steel, Hastelloy® alloy, Monel® alloy and combinations thereof; and suitable plastic include, but are not limited to, ethylene propylene diene monomer (EPDM) rubber, polyvinylchloride (PVC) and combinations thereof. In an embodiment, the third (discharge) shut-off valve 174 (wetted components) may be made of polyvinyl chloride (PVC) and ethylene propylene diene monomer (EPDM) rubber.

An outlet of the third (discharge) valve 169 may be connected to an inlet of the third (discharge) shut-off valve 174 via pipe 172. An outlet of the third (discharge) shut-off valve 174 may be connected to a discharge outlet 176 via pipe 175.

The pipe 172, 175 may be made of any suitable corrosion-resistant pipe. The pipe 172, 175 may be made of any suitable corrosion-resistant metals or plastics. Suitable metals include, but are not limited to, plastic-coated carbon steel, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the pipe 172, 175 may be made of plastic-coated carbon steel. In an embodiment, the pipe 172, 175 may be made of Plasite 7159 HAR-coated carbon steel. In an embodiment, the pipe 172, 175 may be made of 316 stainless steel.

In an embodiment, the pipe 172, 175 may be 2-inch pipe.

### Optional Sensors and Meters

In an embodiment, the system 100, 200 may further comprise a first flow meter 122, 222, a first temperature sensor 130, 230, a first conductivity meter 131, 231, an optional second conductivity meter 132, 232 (not shown), and/or a second flow meter 173, 273.

The first flow meter 122 may be fluidly connected to pipe 120.

The first flow meter 122 may be any suitable flow meter. Suitable first flow meters 122 include, but are not limited to, magnetic, paddlewheel, ultrasonic vortex and insertion-type vortex flow meters. For example, a suitable first flow meter 122 is available from George Fisher Signet LLC. In an embodiment, the first flow meter 122 may be a Signet 2536 Rotor-X Paddlewheel Flow Sensor from George Fisher Signet LLC. In an embodiment, the first flow sensor 122 may be electrically connected to the PLC or computing device 600.

The first temperature sensor 130 may be fluidly connected to the first manifold 128.

The first temperature sensor 130 may be any suitable temperature measuring device. For example, a suitable first temperature sensor 130 is available from Ashcroft Inc. In an embodiment, the first temperature sensor 130 may be a Bi-Metallic Dial Thermometer from Ashcroft Inc. In an embodiment, the first temperature sensor 130 may be electrical or manual.

The first conductivity meter 131 may be fluidly connected to the first manifold 128; and the optional second conductivity meter 132 (not shown) may be fluidly connected to the first manifold 128.

The first conductivity meter 131 monitors the conductivity of the inlet (feed) or condensed (recycled) wastewater from the external wastewater source. If the first conductivity meter 131 measures a predetermined minimum conductivity (e.g., indicating presence of oil in feed water), the system 100 is shut off.

The first conductivity meter 131 may be any suitable conductivity meter. For example, a suitable first conductivity meter 131 is available from Cole-Parmer Instrument Company. In an embodiment, the first conductivity meter 131 may be a Model ML-19504-04 Toroidal Conductivity Sensor from Cole-Parmer Instrument Company. In an embodiment, the first conductivity sensor 131 may be electrically connected to the PLC or computing device 600. In an embodiment, the first conductivity sensor 131 may have a range from about 0 μS/cm to about 1,000,000 μS/cm (and any range or value there between).

The optional second conductivity meter 132 (not shown) monitors the conductivity of the inlet (feed) or condensed (recycle) wastewater from the external wastewater source. If the second conductivity meter 132 indicates the condensed wastewater (brine) has reached a predetermined maximum conductivity, the third (discharge) valve 169 is switched to the OPEN position, the third (discharge) shut-off valve 174 is switched to the OPEN position, and the second (recycle) valve 166 is switched to the CLOSED position.

The optional second conductivity meter 132 may be any suitable conductivity meter. For example, a suitable first conductivity meter 132 is available from Cole-Parmer Instrument Company. In an embodiment, the first conductivity meter 132 may be a Model ML-19504-04 Toroidal Conductivity Sensor electrically connected to a Model ML-94785-12 Process Meter from Cole-Parmer Instrument Company. In an embodiment, the second conductivity sensor 132 may be electrically connected to the PLC or computing device 600. In an embodiment, the second conductivity sensor 132 may have a range from about 0 μS/cm to about 1,000,000 μS/cm (and any range or value there between).

The second flow meter 173 may be fluidly connected to pipe 172. The second flow meter 173 monitors the flow rate of the discharge to the discharge outlet 176.

The second flow meter 173 may be any suitable flow meter. Suitable second flow meters 173 include, but are not limited to, magnetic, paddlewheel, ultrasonic vortex and insertion-type vortex flow meters. For example, a suitable second flow meter 173 is available from George Fisher Signet LLC. In an embodiment, the second flow meter 173 may be a Signet 2536 Rotor-X Paddlewheel Flow Sensor from George Fisher Signet LLC. In an embodiment, the second flow sensor 131 may be electrically connected to the PLC or computing device 600.

### Optional Limit/Level, Pressure and Temperature Switches

In an embodiment, the system 100, 200 further comprises a first pressure switch 110, 210, an air temperature sensor 140, 240, a first high differential pressure switch 147, 247, a second high, high differential pressure switch 148, 248, a first high, high limit switch 149, 249, a low limit switch 150,250, a high limit switch 151, 251, a second high, high limit switch 152, 252, and a second pressure switch 159, 259.

The first pressure switch 110 monitors pressure of inlet wastewater to the first (feed) pump 118. The first pressure switch 110 may be any suitable pressure switch. For example, a suitable first pressure switch 110 is available from AutomationDirect.com Inc. In an embodiment, the first pressure switch 110 may be a ProSense® MPS25 Series Mechanical Pressure Switch from AutomationDirect.com Inc.

The first pressure switch 110 may be fluidly connected to the pipe 108.

The first high differential pressure switch 147 monitors the air pressure in the container 139. If the first high differential pressure switch 147 is activated, the air blower 142 is operating. In an embodiment, the first high differential pressure switch 147 may be set to +/−0.15 inches water column.

The first high differential pressure switch 147 may be any suitable differential pressure sensor. For example, a suitable first high differential pressure switch 147 is available from Dwyer Instruments Inc. In an embodiment, the first high differential pressure switch 147 may be a Series 3000 Photohelic Differential Pressure Gage from Dwyer Instruments Inc. In an embodiment, the first high differential pressure switch 147 has a range from about 0 to about 0.5 inches water column.

The first high differential pressure switch 147 may be fluidly connected to the container 139.

The second high, high differential pressure switch 148 also monitors air pressure in the container. If the second high, high differential pressure switch 148 is activated, the mist arresting system 144 may be blocked due to flooding or scale build-up. In an embodiment, the second high, high differential pressure switch 148, may be set to about +/−0.40 inches water column.

The second high, high differential pressure switch 148 may be any suitable differential pressure sensor. For example, a suitable second high, high differential pressure switch 148 is available from Dwyer Instruments Inc. In an embodiment, the second high, high differential pressure sensor 148 may be a Series 3000MR Photohelic Differential Pressure Gage from Dwyer Instruments Inc. In an embodiment, the second high, high differential pressure switch 148 may have a range from about 0 to about 0.5 inches water column.

The second high, high differential pressure switch 148 may be fluidly connected to the container 139.

The first high, high limit switch 149, low limit switch 150 and high limit switch 151 monitor various water levels in the sump (bottom) of the container 139. The second high, high limit switch 152 monitors water levels in a secondary containment.

The high, high limit switches 149, 152, low limit switch 150, and high limit switch 151 may be any suitable water level switches. Suitable water level switches include, but are not limited to, capacitive proximity, float, magnetic and vibrating fork. For example, the high, high limit switches 149, 152, low limit switch 150, and high limit switch 151 are available from AutomationDirect.com Inc. In an embodiment, the high, high limit switches 149, 152, low limit switch 150, and high limit switch 151 may be TU Series Model M18 Round Inductive Proximity Sensors from AutomationDirect.com Inc.

The first high, high limit switch 149, low limit switch 150, and high limit switch 151 may be fluidly connected near the sump (bottom) of the container 139.

The second high, high limit switch 152 may be fluidly connected outside the container 139 for monitoring water levels in the secondary containment.

The second pressure switch 159 monitors pressure of condensed (recycle) wastewater from the second (recycle) pump 156. The second pressure switch 159 may be any suitable pressure switch. For example, a suitable second pressure switch 159 is available from AutomationDirect.com Inc. In an embodiment, the first pressure switch 159 may be a ProSense® MPS25 Series Mechanical Pressure Switch from AutomationDirect.com Inc.

The second pressure switch 195 may be fluidly connected to pipe 158.

In an embodiment, a pressure gauge 160 displays the pressure of the condensed (recycle) wastewater from the second (recycle) pump 156. The pressure gauge 160 may be fluidly connected to pipe 158.

### Optional Acid Conditioning System

In an embodiment, the system 100 may further comprise an optional acid conditioning system 177. The acid conditioning system 177 comprises an acid tote 178 and an acid metering pump 180.

The acid may be any suitable acid. Suitable acids include, but are not limited to, hydrochloric acid and sulfuric acid. In an embodiment, the acid may be hydrochloric acid (20 baume). In an embodiment, the acid may be sulfuric acid (98%). In an embodiment, the desired pH of the wastewater is about 6.5 or below to minimize calcium carbonate scaling. In an embodiment, the desired pH of the wastewater may be above 6.5 if a scale inhibitor is added to minimize carbonate and non-carbonate scaling. In an embodiment, the amount of acid solution added varies, depending on inlet water conditions (e.g., pH, alkalinity).

In an embodiment, the desired pH of the wastewater may be above 6.5 if a scale inhibitor is added to minimize carbonate and non-carbonate scaling.

An outlet of the acid tote 178 may be fluidly connected to an inlet of the acid metering pump 180 via tubing 179; and an outlet of the acid metering pump 180 is fluidly connected to the container 139 or to the pipe 154 (shown) via tubing 181.

The acid tote 178 may be any suitable acid tote or other bulk chemical storage unit. Suitable acid totes include, but are not limited to, an industry standard shipping tote. For example, a suitable acid tote 178 is available from National Tank Outlet. In an embodiment, the acid tote 178 may be a 275 gallon or a 330 gallon industry standard shipping tote. In an embodiment, the acid tote 178 may be a 55 gallon drum.

The acid metering pump 180 may be any suitable acid metering pump. Suitable acid metering pumps include, but are not limited to, electronic diaphragm, peristaltic and positive displacement pumps. For example, a suitable acid metering pump 180 is available from Anko Products, Inc. In an embodiment, the acid metering pump 180 may be a self-priming peristaltic pump from Anko Products, Inc. In an embodiment, the acid metering pump 180 may be a Mityflex Model 907 self-priming peristaltic pump from Anko Products, Inc.

The tubing 179, 181 may be made of any suitable corrosion-resistant tubing. The tubing 179, 181 may be made of any suitable corrosion-resistant metals or plastics. Suitable metals include but are not limited to, AL-6XN alloy, Hastelloy® alloy, Monel® alloy, and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. For example, suitable tubing 179, 181 may be made of Teflon® PFA or PTFE.

In an embodiment, the acid conditioning system 177 may further comprise an acid flow meter (not shown). The acid flow meter may be fluidly connected to tubing 181. The acid flow meter measures the flow rate of the acid solution.

The acid flow meter may be any suitable flow meter. Suitable acid flow meters include, but are not limited to, paddlewheel, ultrasonic vortex and insertion-type vortex flow meters. For example, a suitable acid flow meter is available from ProMinent. In an embodiment, the acid flow meter may be a Model DulcoFlow DFMa from ProMinent with built-in signal transmission capability.

### Optional Bactericide Conditioning System

In an embodiment, the system 100 may further comprise an optional bactericide conditioning system 182. The bactericide conditioning system 182 comprises a bactericide tote 183 and a bactericide metering pump 185.

The bactericide may be any suitable bactericide. Suitable bactericide includes, but is not limited to, bleach, bromine, chlorine dioxide (generated), 2,2-dibromo-3-nitrilo-propionade (DBNPA), glutaraldehyde, isothiazolin (1.5%) and ozone (generated). In an embodiment, the bactericide may be selected from the group consisting of bleach (12.5%), bromine, chlorine dioxide (generated), DBNPA (20%), glutaraldehyde (50%), isothiazolin (1.5%) and ozone (generated). In an embodiment, the desired bactericide concentration is from about 10 ppm to about 1000 ppm (and any range or value there between). The amount of bactericide solution added to the wastewater varies, depending on inlet water condition.

An outlet of the bactericide tote 183 may be fluidly connected to an inlet of the bactericide metering pump 185 via tubing 184; and an outlet of the bactericide metering pump 185 may be fluidly connected to the container 139 or to the pipe 154 (shown) via tubing 186.

The bactericide tote 183 may be any suitable bactericide tote or other bulk chemical storage unit. Suitable bactericide totes include, but are not limited to, an industry standard shipping tote. For example, a suitable bactericide tote 183 is available from National Tank Outlet. In an embodiment, the bactericide tote 183 may be a 275 gallon or 330 gallon industry standard shipping tote. In an embodiment, the bactericide tote 183 may be a 55 gallon drum or a 5 gallon pail.

In an alternative embodiment, the bactericide tote 183 may be replaced with a suitable bactericide generating apparatus (not shown). For example, a suitable bactericide apparatus is available from Miox Corporation. In an embodiment, the bactericide generating apparatus (not shown) may be a Model AE-8 from Miox Corporation.

The bactericide metering pump 185 may be any suitable bactericide metering pump. Suitable bactericide metering pumps include, but are not limited to, electronic diaphragm, peristaltic and positive displacement pumps. For example, a suitable bactericide metering pump 185 is available from Anko Products, Inc. In an embodiment, the bactericide metering pump 185 may be a self-priming peristaltic pump from Anko Products, Inc. In an embodiment, the bactericide metering pump 185 may be a Mityflex Model 907 self-priming peristaltic pump from Anko Products, Inc.

The tubing 184, 186 may be made of any suitable corrosion-resistant tubing. The tubing 184, 186 may be made of any suitable corrosion-resistant metals or plastics. Suitable metals include, but are not limited to, AL-6XN alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the tubing 184, 186 may be made of Teflon® PFA or PTFE.

In an embodiment, the bactericide conditioning system 182 may further comprise an optional bactericide flow meter (not shown). The bactericide flow meter may be fluidly connected to tubing 186. The bactericide flow meter measures the flow rate of the bactericide solution.

The bactericide flow meter may be any suitable flow meter. Suitable bactericide flow meters include, but are not limited to, paddlewheel, ultrasonic vortex and insertion-type vortex flow meters. For example, a suitable bactericide flow meter is available from ProMinent. In an embodiment, the bactericide flow meter may be a Model DulcoFlow DFMa from ProMinent with built-in signal transmission capability.

### Optional Scale Inhibition Conditioning System

In an embodiment, the system 100 may further comprise an optional scale inhibition conditioning system 187. The scale inhibition conditioning system 187 comprises a scale inhibition tote 188 and a scale inhibition metering pump 190.

The scale inhibitor may be any suitable scale inhibitor or blend of scale inhibitors. A suitable scale inhibitor includes, but is not limited to, inorganic phosphates, organophosphorous compounds and organic polymers. In an embodiment, the scale inhibitor may be selected from the group consisting of organic phosphate esters, polyacrylates, phosphonates, polyacrylamides, polycarboxylic acids, polymalates, polyphosphincocarboxylates, polyphosphates and polyvinylsylphonates. In an embodiment, the desired scale inhibitor concentration is from about 10 ppm to about 100 ppm (and any range or value there between). In an embodiment, the desired scale inhibitor concentration is from about 2 ppm to about 20 ppm (and any range or value there between). The amount of scale inhibitor solution added to the wastewater varies, depending on inlet water condition.

An outlet of the scale inhibition tote 188 may be fluidly connected to an inlet of the scale inhibition metering pump 190 via tubing 189; and an outlet of the scale inhibition metering pump 190 may be fluidly connected to container 139 (shown) or to pipe 154 via tubing 191.

The scale inhibition tote 188 may be any suitable scale inhibition tote or other bulk chemical storage unit. Suitable scale inhibition totes include, but are not limited to, an industry standard shipping tote. For example, a suitable scale inhibition tote 188 is available from National Tank Outlet. In an embodiment, the scale inhibition tote 188 may be a 275 gallon or 330 gallon industry standard shipping tote. In an embodiment, the scale inhibition tote 188 may be a 55 gallon drum or a 5 gallon pail.

The scale inhibition metering pump 190 may be any suitable scale inhibitor metering pump. Suitable scale inhibition metering pumps include, but are not limited to, electronic diaphragm, peristaltic and positive displacement pumps. For example, a suitable scale inhibition metering pump 190 is available from Anko Products, Inc. In an embodiment, the scale inhibition metering pump 190 may be a self-priming peristaltic pump from Anko Products, Inc. In an embodiment, the scale inhibition metering pump 190 may be a Mityflex Model 907 self-priming peristaltic pump from Anko Products, Inc.

The tubing 189, 191 may be made of any suitable corrosion-resistant tubing. The tubing 189, 191 may be made of any suitable corrosion-resistant metals or plastics. Suitable metals include but are not limited to, plastic-coated carbon steel, stainless steel, super-duplex stainless steel, AL-6XN alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the tubing 189, 191 may be made of Teflon® PFA or PTFE.

In an embodiment, the scale inhibition conditioning system 187 further comprises an optional scale inhibition flow meter (not shown). The scale inhibition flow meter may be fluidly connected to tubing 191. The scale inhibition flow meter measures the flow rate of the scale inhibitor solution.

The scale inhibitor flow meter may be any suitable flow meter. Suitable scale inhibitor flow meters include, but are not limited to, paddlewheel, ultrasonic vortex and insertion-type vortex flow meters. For example, a suitable scale inhibitor flow meter is available from ProMinent. In an embodiment, the scale inhibitor flow meter may be a Model DulcoFlow DFMa from ProMinent with built-in signal transmission capability.

### Optional Defoamer System

In an embodiment, the system 100 may further comprise an optional defoamer system 192. The defoamer system 192 comprises a defoamer tote 193 and a defoamer pump 195.

The defoamer may be any suitable defoamer. Suitable defoamer includes, but is not limited to, alcohols, glycols, insoluble oils, silicone polymers and stearates. In an embodiment, the defoamer may be selected from the group consisting of fatty alcohols, fatty acid esters, fluorosilicones, polyethylene glycol, polypropylene glycol, silicone glycols and polydimethylsiloxane. In an embodiment, the desired defoamer concentration is from about 10 ppm to about 100 ppm (and any range or value there between). In an embodiment, the desired defoamer concentration is from about 2 ppm to about 20 ppm (and any range or value there between). The amount of defoamer solution added to the wastewater varies, depending on inlet water condition.

An outlet of the defoamer tote 193 may be fluidly connected to an inlet of the defoamer metering pump 195 via tubing 194; and an outlet of the defoamer metering pump 195 may be fluidly connected to container 139 (shown) or to pipe 154 via tubing 196.

The defoamer tote 193 may be any suitable defoamer tote or other bulk chemical storage unit. Suitable defoamer totes include, but are not limited to, an industry standard shipping tote. For example, a suitable defoamer tote 193 is available from National Tank Outlet. In an embodiment, the scale defoamer tote 193 may be a 275 gallon or 330 gallon industry standard shipping tote. In an embodiment, the defoamer tote 193 may be a 55 gallon drum or a 5 gallon pail.

The defoamer metering pump 195 may be any suitable defoamer metering pump. Suitable defoamer metering pumps include, but are not limited to, electronic diaphragm, peristaltic, and positive displacement pumps. For example, a suitable defoamer metering pump 195 is available from Anko Products, Inc. In an embodiment, the defoamer metering pump 195 may be a self-priming peristaltic pump from Anko Products, Inc. In an embodiment, the defoamer metering pump 195 may be a Mityflex Model 907 self-priming peristaltic pump from Anko Products, Inc.

The tubing 194, 196 may be made of any suitable corrosion-resistant tubing. The tubing 194, 196 may be made of any suitable corrosion-resistant metals or plastics. Suitable metals include, but are not limited to, plastic-coated carbon steel, stainless steel, super-duplex stainless steel, AL-6XN alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the tubing 194, 196 may be made of Teflon® PFA or PTFE.

In an embodiment, the defoamer conditioning system 192 may further comprise an optional defoamer flow meter (not shown). The defoamer flow meter may be fluidly connected to tubing 196. The defomer flow meter measures the flow rate of the defoamer solution.

The defoamer flow meter may be any suitable flow meter. Suitable defoamer flow meters include, but are not limited to, paddlewheel, ultrasonic vortex and insertion-type vortex flow meters. For example, a suitable defoamer flow meter is available from ProMinent. In an embodiment, the defoamer flow meter may be a Model DulcoFlow DFMa from ProMinent with built-in signal transmission capability.

### System for Spray Evaporation of Water Illustrating Alternative Embodiments

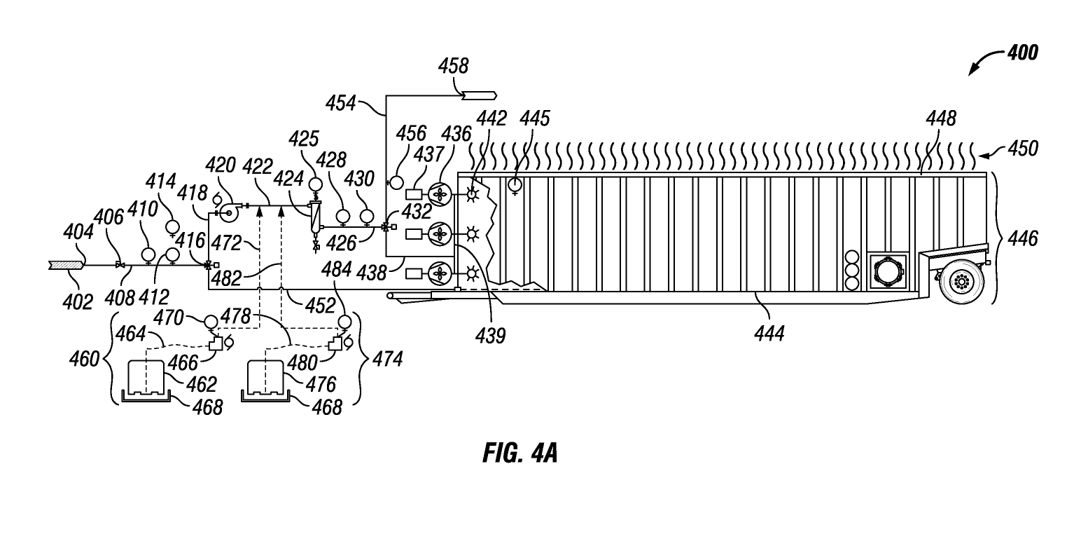

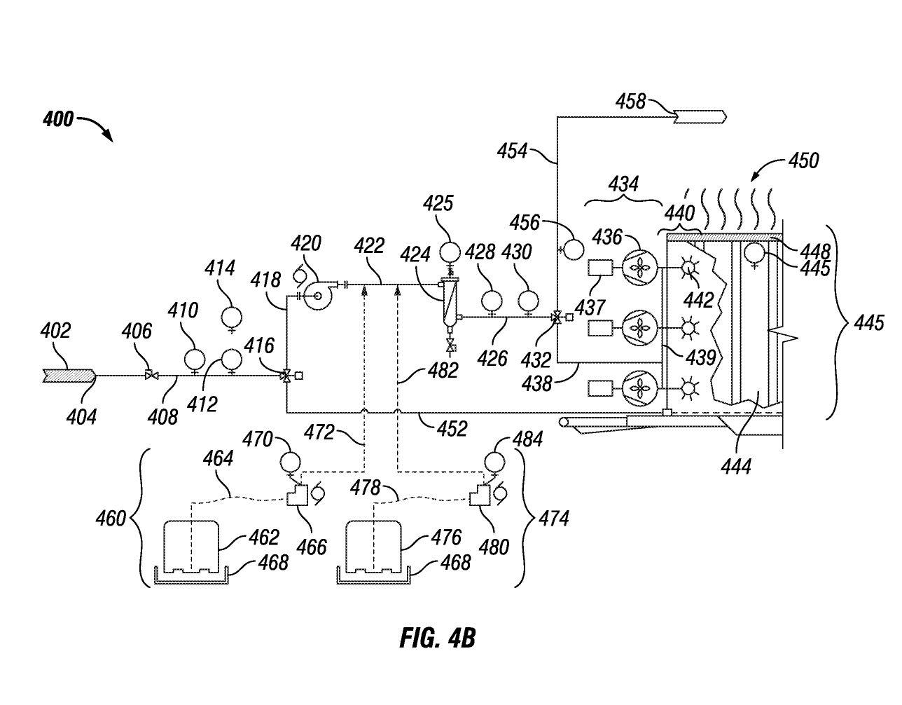

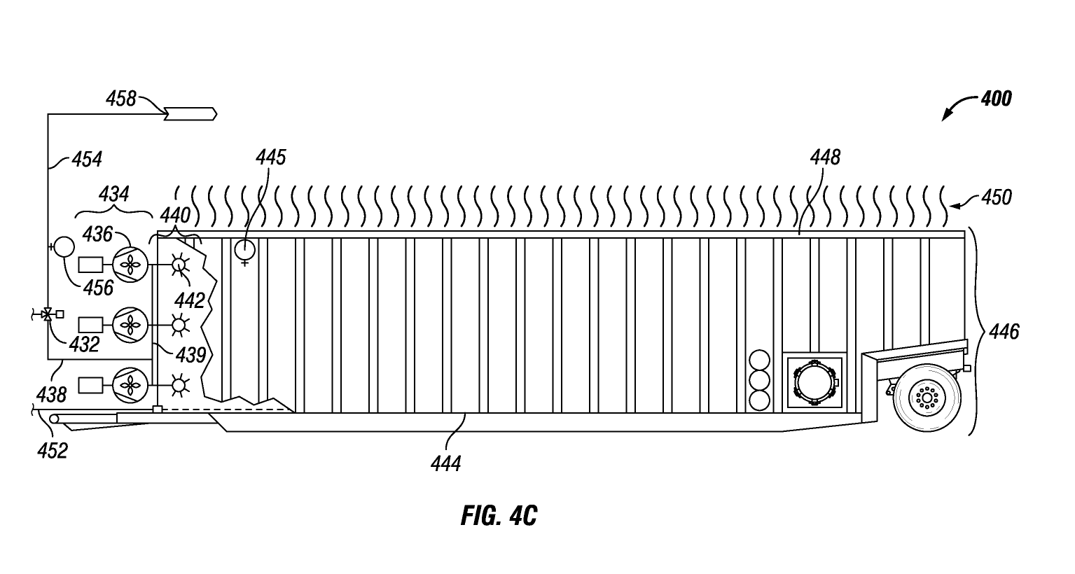

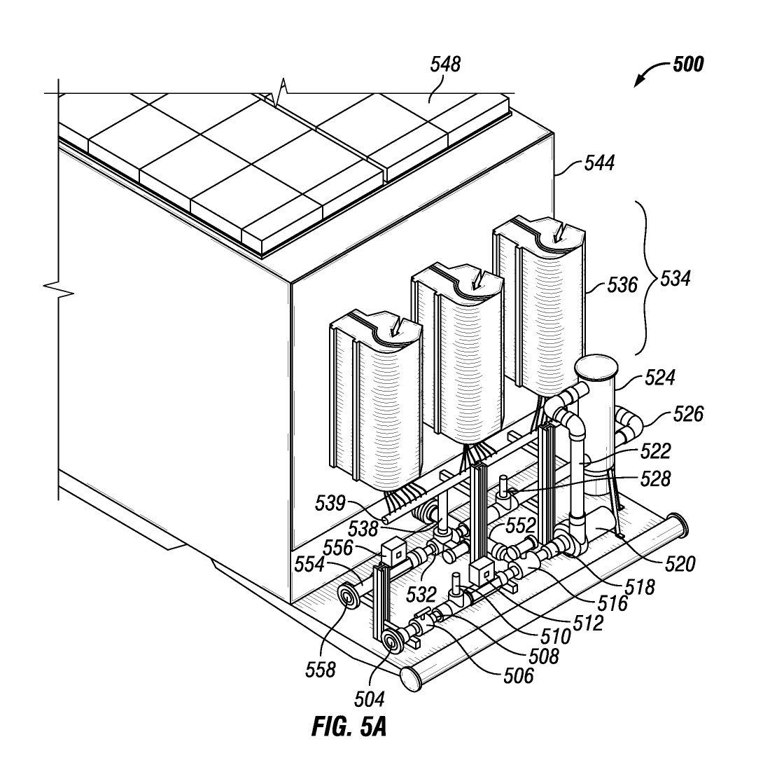

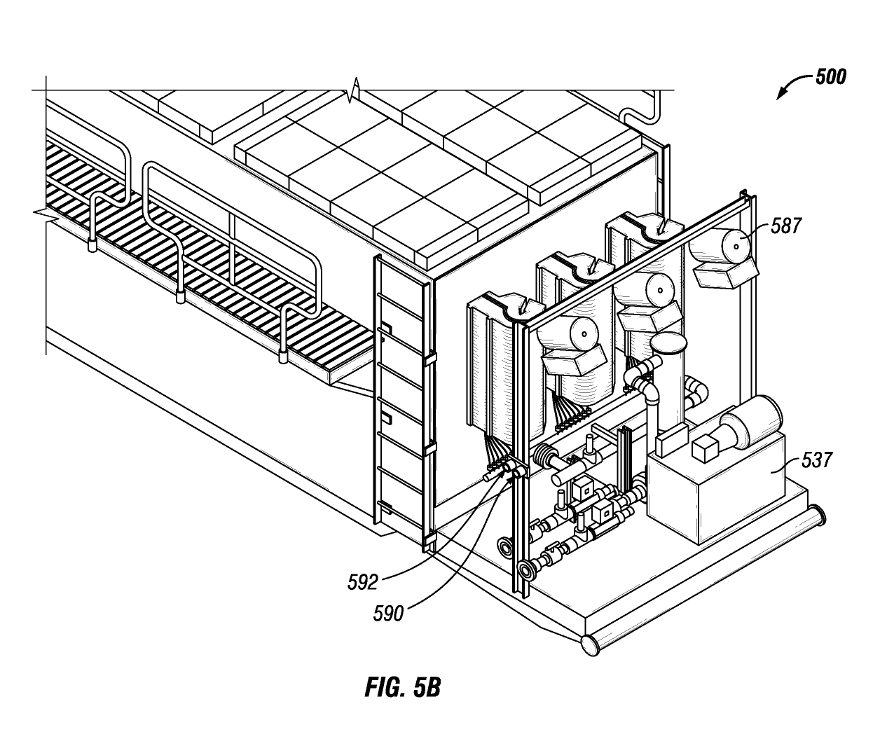

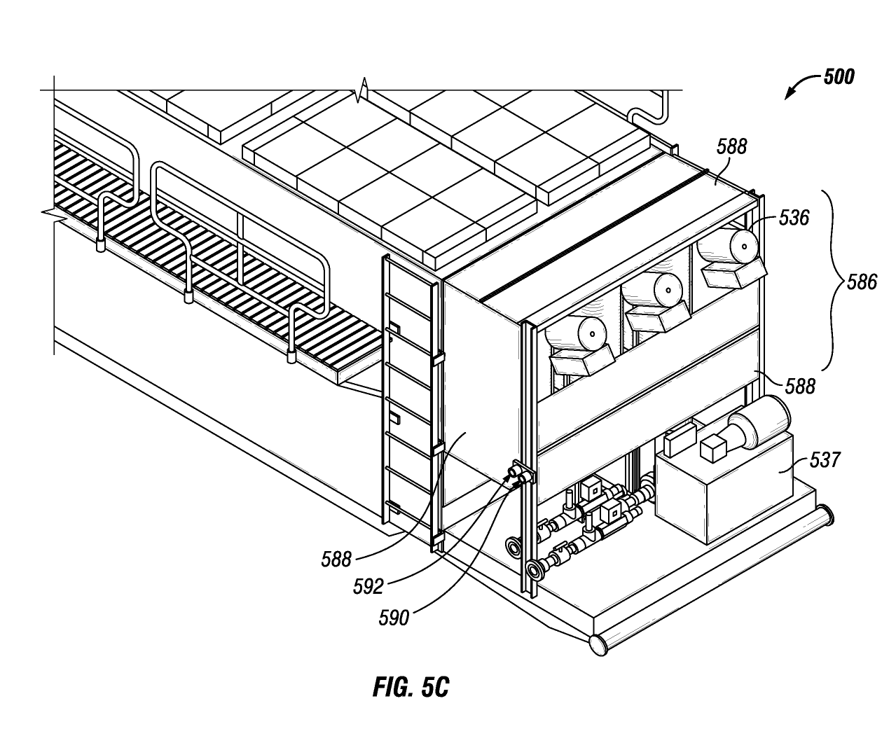

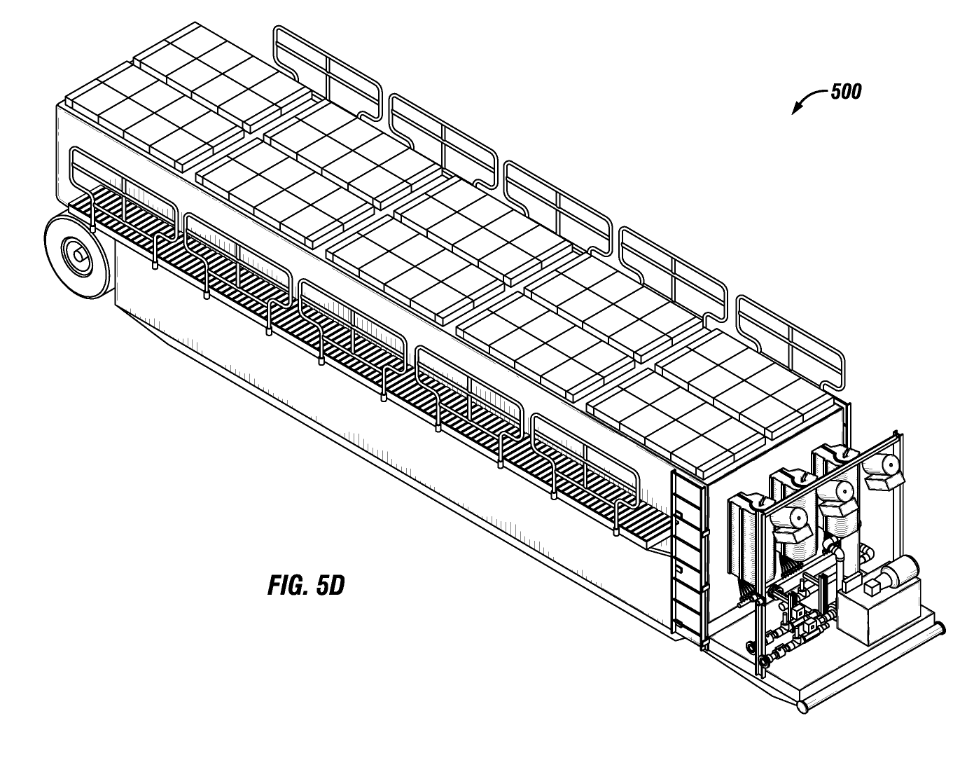

A schematic of an exemplary system 400, 500 for spray evaporation of water according to another embodiment of the present invention is shown in FIGS. 4A-5D. The system 400, 500 comprises a wastewater inlet 404, 504, a pump 420, 520, an air blower 436, 536, a manifold 439, 539, a spray nozzle 442, 542, a container 444, 544, a demister element 448, 548, and a discharge outlet 458, 558.

In an embodiment, the system 400, 500 is capable of evaporating between about 2,000 to about 10,000 gallons of wastewater per day (see FIGS. 4A-5D). If a higher throughput is desired, a plurality of system 400, 500 may be used in parallel to treat the wastewater.

### Inlet System

The wastewater inlet 404 may be connected to an inlet of the first 3-way valve 416 via a pipe 408. An outlet of the 3-way valve 416 may be connected to an inlet of the pump 420 via a pipe 418.

The wastewater inlet 404 may be any suitable wastewater inlet that can handle up to about 40 psi. Suitable wastewater inlets include, but are not limited to, flange connections, cam-lock fittings and hammer unions. In an embodiment, the wastewater inlet 404 is a flange connection (see FIGS. 5A-5D). The wastewater inlet 404 permits connection to an external wastewater source. The water inlet 404 may be connected to the external wastewater source via a hose, pipe or other means customary in the art.

In an embodiment, the system 400, 500 may further comprise a first 3-way valve 416, 516. The first 3-way valve 416 may be any suitable 3-way valve. The first 3-way valve 416 may be automatic or manual. The first 3-way valve 416 may be electric or pneumatic actuation. Suitable 3-way valves include, but are not limited to, ball valves. For example, a suitable first 3-way valve 416 is available from GF Piping Systems. In an embodiment, the first 3-way valve 416 may be a Georg Fisher Type 543 3-Way Ball Valve from GF Piping Systems.

The pump 420 may be any suitable pump. Suitable pumps include, but are not limited to, positive suction pumps. For example, a suitable pump 420 is available from Ampco. In an embodiment, the pump 420 may be a 3 to 5 horse power positive suction pump from MP Pumps.

The pump 420 may be made of any suitable corrosion-resistant material. The pump 420 may be made of any suitable corrosion-resistant metals or plastics. Suitable metals include, but are not limited to, cast iron, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. For example, the pump 420, including internal wetted components, may be made of stainless steel, super-duplex stainless steel, AL-6XN alloy, Ni—Al—Brz alloy, Hastelloy® alloy, Monel® alloy or FRD. In an embodiment, the pump 420, including internal wetted components, may be made of super-duplex stainless steel. In an embodiment, pump 420 may be made of cast iron if a shorter service life is acceptable.

The pipe 418 may be made of any suitable corrosion-resistant pipe. The pipe 418 may be any suitable metal or plastic pipe. Suitable metals include but are not limited to, plastic-coated carbon steel, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the pipe 418 may be made of plastic-coated carbon steel. In an embodiment, the pipe 418 may be made of Plasite 7159 HAR-coated carbon steel. In an embodiment, the pipe 418 may be made of 316 stainless steel.

In an embodiment, the pipe 418 may be 2-inch pipe.

An outlet of the pump 420 may be connected to an inlet of the second 3-way valve 432 via pipe(s) 422, 426. A first outlet of the second 3-way valve 432 may be connected to a manifold 439 via a pipe 438.

A first outlet of the air blower 436′ may be fluidly connected to a blower inlet of the manifold 439 opposite a spray outlet of the manifold 439, a second outlet of a second air blower 436″ may be fluidly connected to a second blower inlet of the manifold 439 opposed to a second spray outlet of the manifold 439, and so on.

In an embodiment, each outlet of the air blower 436 may be connected to its corresponding blower inlet of the manifold 439 via tubing. In an embodiment, the tubing may be made of 316 stainless steel. In an embodiment, the tubing may be ⅜-inch tubing.

In an embodiment, each spray outlet of the pipe 438 may be connected to an inlet of the spray nozzle 442 via tubing. In an embodiment, each spray outlet of the manifold 439 comprises about 4 to about 6 tubes (see FIGS. 5A-5B). In an embodiment, the tubing may be made of 316 stainless steel. In an embodiment, the tubing may be ⅜-inch tubing.

In an embodiment, the system 400 may further comprise a second 3-way valve 432. The second 3-way valve 432 may be any suitable 3-way valve. The second 3-way valve 432 may be automatic or manual. The second 3-way valve 432 may be electric or pneumatic actuation. Suitable 3-way valves include, but are not limited to, ball valves. For example, a suitable second 3-way valve 432 is available from GF Piping Systems. In an embodiment, the second 3-way valve 432 may be a Georg Fisher Type 543 3-Way Ball Valve from GF Piping Systems. In an embodiment, the first 3-way valve 416 and the second 3-way valve 432 may be the same type.

In an embodiment, the second 3-way valve 432 has 2-inch connections.

The air blowers 436 may be any suitable air blower. The air blower 436 may be automatic or manual. The air blowers 436 may be electric or hydraulic (see FIGS. 4A-4C). Suitable air blowers include, but are not limited to, variable-speed air blowers. For example, a suitable plurality of air blowers 436 is available from Curtec. In an embodiment, the air blower 436 may be a variable-speed air blower capable of moving from about 1 k to about 35 k CFM from Curtec. In an embodiment, the air blower 436 may be a variable-speed air blower capable of moving from about 3 k to about 18 k CFM total from Curtec. In an embodiment, the air blower 436 may be a variable-speed air blower capable of moving from about 15 k to about 35 k CFM total from Curtec.

The pipe 422, 426, 438 may be made of any suitable corrosion-resistant pipe. The pipe 422, 426, 438 may be made of any suitable corrosion-resistant metals or plastics. Suitable metals include, but are not limited to, plastic-coated carbon steel, stainless steel, super-duplex stainless steel, AL-6XN alloy, Ni—Al—Brz alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the pipe 422, 426, 438 may be made of plastic-coated carbon steel. In an embodiment, the pipe 422, 426, 438 may be made of Plasite 7159 HAR-coated carbon steel. In an embodiment, the pipe 422, 426, 438 may be made of 316 stainless steel.

In an embodiment, the pipe 422, 426, 438 may be 2-inch pipe.

An outlet of the air blower 436 may be connected to an inlet of the spray nozzle 442 via the manifold 439, as discussed above. An outlet of the spray nozzle 442 discharges water droplets inside the container 444. An upper portion or top side of the container 444 is enclosed with the demister element 448 to retain the water droplets inside the container 444. The demister element 448 is secured to and supported by the container 444 in a manner customary in the art. In an embodiment, a water to air ratio may range from about 15 GPM/150,000 CFM to about 100 GPM/60,000 CFM (and any range or value there between). In an embodiment, the water to air ratio is about 16 GPM/127,000 CFM.

At least some of the water droplets evaporate to form water vapor. The water vapor passes through the demister element 448 and out the evaporated water outlet 450. Any un-evaporated water is retained by the demister element 448 and falls to the sump (bottom) of the container 444.

The spray nozzle 442 may be any suitable spray nozzle. Suitable spray nozzles include, but are not limited to, rotary atomizers. For example, a suitable spray nozzle 442 is available from Ledebuhr Industries. In an embodiment, the spray nozzle 442 may be a variable-speed rotary atomizer from Ledebuhr Industries. In an embodiment, the rotary atomizer may be capable of high flow. In an embodiment, the rotary atomizer has a plurality of spray heads. In an embodiment, the rotary atomizer may be capable of about 8 gallon per minute (GPM) flow per spray head. In an embodiment, the rotary atomizer produces water droplet sizes from about 50 μm to about 300 μm. In an embodiment, the rotary atomizer may produce water droplet sizes from about 50 μm to about 150 μm. In an embodiment, the spray heads are positioned at the discharge point of the air blower. Alternatively, the spray heads are positioned inside the container.

The spray nozzle 442 may be made of any suitable corrosion-resistant material. The spray nozzle 442 may be made of any suitable corrosion-resistant metals. Suitable metals, include, but are not limited to, stainless steel, Hastelloy® alloy, Monel® alloy and combinations thereof. In an embodiment, the spray nozzle 442 (spray head) may be made of 316 stainless steel.

The container 444 may be any suitable container. The container 444 may be mobile or it may be stationary. Suitable containers include, but are not limited to, frac tanks (see FIGS. 5A-5C). For example, a suitable container 444 is available from PCI Manufacturing, LLC. In an embodiment, the container 444 may be an OPT FRAC, 500BBL, S/E, CIRC Line frac tank from PCI Manufacturing, LLC.

Alternatively, the container 444 may be made of any suitable corrosion-resistant material. The container 444 may be made of coated metals, corrosion-resistant metals or plastics. Suitable coated metals include, but are not limited to, plastic-coated carbon steel; suitable corrosion-resistant metals include, but are not limited to, stainless steel, Hastelloy® alloy, Monel® alloy and combinations thereof; and suitable plastics include, but are not limited to, polyethylene, polypropylene, polyvinyl chloride (PVC) and combinations thereof. In an embodiment, the container 444 may be made of plastic-coated carbon steel. In an embodiment, the container 444 may be made of Plasite 7159 HAR-coated carbon steel.

The container 444 may be any suitable shape. Suitable shapes include, but are not limited to, cylindrical, cubic, cuboid, prism, pyramid, spherical and combinations thereof. In an embodiment, the container 444 may be approximately a cuboid shape.

The demister element 448 may be any suitable demister element. The demister element 448 may be made of any suitable corrosion-resistant material. The demister element 448 may be made of any suitable corrosion-resistant metals or plastics. The demister element 448 may be made of metal or plastic mesh or baffled, torturous-path chevron-type plates. Suitable metal mesh includes, but is not limited to, stainless steel, Hastelloy® alloy, Monel® alloy and combinations thereof; suitable plastic mesh includes, suitable plastic mesh includes, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof; and suitable chevron-type plates include, but are not limited to, polyethylene, polypropylene, polyvinylchloride (PVC), stainless steel, Teflon® perfluoroalkoxy (PFA) polymers, Teflon® polytetrafluroethylene (PTFE) polymers. In an embodiment, the demister element 448 may be made of 316 stainless steel.

The demister element 448 may be any suitable shape to enclose an upper portion of the container 444. Suitable shapes include, but are not limited to, cylindrical, cubic, cuboid, prism, pyramid, spherical, and portions and combinations thereof. In an embodiment, the demister element 448 may be a cuboid shape about 4-feet wide by about 8-feet long and about 4-inches to about 6-inches thick. As shown in FIG. 4, the demister element 448 forms an upper portion of the cuboid shape of the container 444.

The evaporated water outlet 450 comprises a plurality of outlet pores (not shown) in the demister element 448.

### Recycle and Discharge System

The bottom of the container 444 may be connected to a second inlet to the first 3-way valve 416 via pipe 452. The outlet of the first 3-way valve 416 may be connected to the inlet of the pump via pipe 418. The outlet of the pump 420 may be connected to the inlet of the second 3-way valve 432 via pipe(s) 422, 426. A second outlet of the second 3-way valve 432 may be connected to the discharge outlet 458 via pipe 454.

The discharge outlet 458 may be any suitable outlet that can handle up to about 40 psi. Suitable discharge outlets include, but are not limited to, a flange connection, cam-lock fittings and hammer unions. In an embodiment, the discharge outlet 458 is a flange connection (see FIGS. 5A-5D). The discharge outlet 458 permits connection to an external waste disposal storage (e.g., tank, truck, pond). The discharge outlet 458 may be connected to the external waste disposal storage via hose, pipe or other means as customary in the art.

### Alternate Air Blower, Spray System and Mist Arresting System

In an embodiment, the system 400, 500 further comprises an air blower system 434, 534, a spray system 440, 540 and a mist arresting system 446, 546. The air blower system 434 comprises a plurality of air blowers 436′, 436″; the spray system 440 comprises a plurality of spray nozzles 442′, 442″; and the mist arresting system 446 comprises a plurality of demister elements 448′, 448″ and the container 444.

A first outlet of a first air blower 436′ may be fluidly connected to a first blower inlet of the manifold 439 opposed to a first spray outlet of the manifold 439; and a second outlet of a second air blower 436″ may be fluidly connected to a second blower inlet of the manifold 439 opposite a second spray outlet of the manifold 439, and so on.

In an embodiment, each outlet of the plurality of air blowers 436′, 436″ may be connected to its corresponding blower inlet of the manifold 439 via tubing. In an embodiment, the tubing may be made of 316 stainless steel. In an embodiment, the tubing may be ⅜-inch tubing.

In an embodiment, the air blower system 534 may further comprise an air heating system 586. The air heating system 586 comprises an air ducting plenum 588 and a heater 587 (see FIG. 5C). In an embodiment, the air heating system 586 further comprises a first thermometer 590 to measure the temperature of inlet air and/or a second thermometer 592 to measure the temperature of outlet air (see FIGS. 5B-5C).

In an embodiment, each spray outlet of the manifold 439, 539 may be connected to its corresponding inlet of the spray nozzle 442, via tubing. In an embodiment, each spray outlet of the manifold 439, 539 comprises about 4 to about 6 tubes (see FIGS. 5A-5B). In an embodiment, the tubing may be made of 316 stainless steel. In an embodiment, the tubing may be ⅜-inch tubing.

Outlets of the plurality of spray nozzles 442′, 442″ discharge water droplets inside the container 444. An upper portion or top side of the container 444 is enclosed with the plurality of demister elements 448′, 448″ to retain the water droplets inside the container 444. The plurality of demister elements 448′, 448″ are secured to and supported by the container 444 in a manner customary in the art.

At least some of the water droplets evaporate to form water vapor. The water vapor passes through pores in the plurality of demister elements 448′, 448″ and out the evaporated water outlet 450. Any un-evaporated water is retained by the plurality of demister elements 448′, 448″ and falls to the sump (bottom) of the container 444.

The evaporated water outlet 450 comprises a plurality of outlet pores (not shown) in the plurality of demister elements 448′, 448″.

The plurality of air blowers 436′, 436″ may be any suitable air blowers. The plurality of air blowers 436′, 436″ may be automatic or manual. The plurality of air blowers 436′, 436″ may be electric or hydraulic (see FIG. 4A-4C). Suitable air blowers include, but are not limited to, variable-speed air blowers. For example, suitable plurality of air blowers 436′, 436″ are available from Curtec. In an embodiment, the plurality of air blowers 436′, 436″ are variable-speed air blowers capable of moving from about 1 k to about 6 k CFM per blower from Curtec. In an embodiment, the plurality of air blowers 436′, 436″ are variable-speed air blowers capable of moving from about 1 k to about 35 k CFM total from Curtec. In an embodiment, the plurality of air blowers 436′, 436″ are variable-speed air blowers capable of moving from about 3 k to about 18 k CFM total from Curtec. In an embodiment, the plurality of air blowers 436′, 436″ are variable-speed air blowers capable of moving from about 15 k to about 35 k CFM total from Curtec.

The plurality of spray nozzles 442′, 442″ may be any suitable spray nozzles. Suitable plurality of spray nozzles include, but are not limited to, rotary atomizers. For example, a suitable plurality of spray nozzles 442′, 442″ are available from Ledebuhr Industries. In an embodiment, the plurality of spray nozzles 442′, 442″ are variable-speed rotary atomizers from Ledebuhr Industries. In an embodiment, the rotary atomizers are capable of high flow. In an embodiment, the rotary atomizers have a plurality of spray heads. In an embodiment, the rotary atomizers are capable of about 8 GPM flow per spray head. In an embodiment, the spray heads are positioned at the discharge point of the air blower. Alternatively, the spray heads are positioned inside the container.

The plurality of spray nozzles 442′, 442″ may be made of any suitable corrosion-resistant material. The plurality of spray nozzles 442′, 442″ may be made of any suitable corrosion-resistant metals. Suitable corrosion-resistant metals include, but are not limited to, stainless steel, Hastelloy® alloy, Monel® alloy and combinations thereof. In an embodiment, the plurality of spray nozzles 442′, 442″ (spray heads) are made of 316 stainless steel.

The plurality of demister elements 448′, 448″ may be any suitable demister elements. The plurality of demister elements 448′, 448″ may be made of any suitable corrosion-resistant material. The plurality of demister elements 448′, 448″ may be made of metal or plastic mesh or baffled, torturous path chevron-type plates. Suitable metal mesh includes, but is not limited to, stainless steel, Hastelloy® alloy, Monel® alloy and combinations thereof; suitable plastic mesh includes, suitable plastic mesh includes, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof; and suitable chevron-type plates include, but are not limited to, polyethylene, polypropylene, polyvinylchloride (PVC), stainless steel, Teflon® perfluoroalkoxy (PFA) polymers, Teflon® polytetrafluroethylene (PTFE) polymers. In an embodiment, the plurality of demister elements 448′, 448″ are made of 316 stainless steel.

In an embodiment, the demister element 448 may be about 4-inches to about 6-inches thick. In an embodiment, the demister element 448 may be about 4-feet wide by about 8-feet long.

### Optional Shut-Off Valves

In an embodiment, the system 400, 500 may further comprise an optional shut-off valve 406, 506 and an optional discharge shut-off valve (not shown). The shut-off valve 406 is disposed in the pipe 408, connecting the water inlet 404 to the first inlet of the first 3-way valve 416. The optional discharge shut-off valve is disposed in the pipe 454, connecting an outlet of the second 3-way valve 432 to the discharge outlet 458.

The shut-off valve 406 and the discharge shut-off valve may be any suitable shut-off valve. The shut-off valve 406 and the optional discharge shut-off valve may be automatic or manual. Suitable shut-off valves include, but are not limited to, ball valves and butterfly valves. For example, a suitable shut-off valve 406 is available from GF Piping Systems. In an embodiment, the shut-off valve 406 may be a Georg Fischer Type 563 Butterfly Valve.

In an embodiment, the shut-off valve 406 has 2-inch connections.

The shut-off valve 406 and the optional discharge shut off valve may be made of any suitable corrosion-resistant material. The shut-off valve 406 and optional discharge shut-off valve may be made of any suitable corrosion-resistant metals or plastics. Suitable metals include, but are not limited to, plastic-coated carbon steel, stainless steel, Hastelloy® alloy, Monel® alloy and combinations thereof; and suitable plastics include, but are not limited to, ethylene propylene diene monomer (EPDM) rubber, polyvinylchloride (PVC) and combinations thereof. In an embodiment, the shut-off valve 106 (wetted components) may be made of polyvinyl chloride (PVC) and ethylene propylene diene monomer (EPDM) rubber.

### Optional Basket Strainer

In an embodiment, the system 400, 500 may further comprise a basket strainer 424, 524 and an optional pressure sensor 425, 525. An inlet of the basket strainer 424 may be fluidly connected to an outlet of pipe 422, and an outlet of the basket strainer 424 may be fluidly connected to an inlet of pipe 426. In an embodiment, the first pressure sensor 425 may be fluidly connected to either the pipe 422 or the inlet of the basket strainer 424. The basket strainer 424 retains debris in the water feed to prevent clogging of the spray nozzles 442.

The basket strainer 424 may be any suitable basket strainer. A suitable basket strainer 424 includes, but is not limited to, 1/16-inch perforated baskets, contained within a simplex or duplex housing. For example a suitable basket strainer 424 is available from Hayward or Rosedale. In an embodiment, the basket strainer 424 may be a 1/16-inch perforated basket from Hayward or Rosedale.

The basket strainer 424 may be made of any suitable corrosion-resistant material. The basket strainer 424 may be made of any suitable corrosion-resistant metals. The basket strainer 424 may be any suitable metal or plastic basket strainer. Suitable metals include, but are not limited to, stainless steel, Hastelloy® alloy, Monel® alloy and combinations thereof; and suitable plastics include, but are not limited to, chlorinated polyvinyl chloride (CPVC) polymers, Kynar® polyvinylidene fluoride (PVDF) polymers, polyvinyl chloride (PVC) polymers, Teflon® perfluoroalkoxy (PFA) polymers, Teflon® polytetrafluroethylene (PTFE) polymers, and combinations thereof. In an embodiment, the basket strainer 424 (basket) may be made of 316 stainless steel.

The optional pressure sensor 425 may be any suitable pressure sensor. For example, a suitable pressure sensor 425 is available from Rosemount, Inc. In an embodiment, the pressure sensor 425 may be a Rosemount 2088 Absolute and Gage Pressure Transmitter from Rosemount, Inc.

### Optional Sensors and Meters

In an embodiment, the system 400, 500 may further comprise a first conductivity meter 410, 510, a first flow meter 412, 512 and/or a hygrometer 414, 514. The first conductivity meter 410 and the flow meter 412 may be fluidly connected to pipe 408. The first conductivity meter 410 monitors the conductivity of the inlet or condensed wastewater from the external wastewater source; and the first flow meter 412 measures the flow rate of the inlet wastewater or condensed water.

The first conductivity meter 410 may be any suitable conductivity meter. For example, a suitable first conductivity meter 410 is available from Mettler-Toledo AG or Advanced Sensor Technologies, Inc. (ASTI). In an embodiment, the first conductivity meter 410 may be an InPro 7100 Series Conductivity Sensor from Mettler-Toledo AG electrically connected to a Multiparameter Transmitter M400 from Mettler-Toledo AG. In an embodiment, the first conductivity meter 410 may be a Model ASTX-37PP-PT1000-20-TL-1056 Toroidal Conductivity Sensor from ASTI electrically connected to a Model 1056-01-21-32-AN Dual Channel Transmitter from ASTI.

The hygrometer 414 is fluidly exposed to ambient air near system 400. The hygrometer 414 measures barometric pressure, humidity and temperature of the ambient air near the system 400.

The hygrometer 414 may be any suitable hygrometer. For example a suitable hygrometer is available from Yankee Environmental Systems, Inc. In an embodiment, the hygrometer 414 may be a Metrological Thermo-Hygrometer Model PTU-2000 from Yankee Environmental Systems, Inc.

The first flow meter 412 may be any suitable flow meter. Suitable first flow meters include, but are not limited to, magnetic, paddlewheel, ultrasonic vortex and insertion-type vortex flow meters. For example, a suitable first flow meter 412 is available from Mettler-Toledo Thornton, Inc. In an embodiment, the first flow meter 412 may be a Model 8030 from Mettler-Toledo Thornton, Inc. electrically connected to a Multiparameter Transmitter M400 from Mettler-Toledo AG.

In an embodiment, the system 400, 500 further comprises a second conductivity meter 428, 528 and a pH meter 430, 530. The second conductivity meter 428 may be fluidly connected to pipe 426; and the pH meter 430 may be fluidly connected to pipe 426. The second conductivity meter 428 monitors the conductivity of the wastewater; and the pH meter 430 measures the pH of the wastewater.

The second conductivity meter 428 may be any suitable conductivity meter. For example, a suitable second conductivity meter 428 is available from Mettler-Toledo AG or Advanced Sensor Technologies, Inc. (ASTI). In an embodiment, the second conductivity meter 428 may be an InPro 7100 Series Conductivity Sensor from Mettler-Toledo AG electrically connected to a Multiparameter Transmitter M400 from Mettler-Toledo AG. In an embodiment, the first conductivity meter 410 may be a Model ASTX-37PP-PT1000-20-TL-1056 Toroidal Conductivity Sensor from ASTI electrically connected to a Model 1056-01-21-32-AN Dual Channel Transmitter from ASTI. In an embodiment, the first conductivity meter 410 and the second conductivity meter 428 may be the same type.

The pH meter 430 may be any suitable pH meter. For example, a suitable pH meter 430 is available from Mettler-Toledo AG or Advanced Sensor Technologies, Inc. (ASTI). In an embodiment, the pH meter 430 may be an InPro 3300 Non-Glass Electrode for pH Measuring Systems from Mettler-Toledo AG electrically connected to a Multiparameter Transmitter M400 from Mettler-Toledo AG. In an embodiment, the pH meter 430 may be a Model PNGR 8951-1000-20-TL-WPB Submersible Saturated Brine Resistant pH Sensor from ASTI electrically connected to a Model 1056-01-21-32-AN Dual Channel Transmitter from ASTI.

In an embodiment, the system 400 further comprises a differential pressure sensor 445. The differential pressure sensor 445 measures the pressure drop across the demister element 448 or the plurality of demister elements 448′, 448″.

The differential pressure sensor 445 may be any suitable differential pressure sensor. For example, a suitable differential pressure sensor 445 is available from Dwyer Instruments Inc. In an embodiment, the differential pressure sensor 445 may be a Series 3000 Photohelic Differential Pressure Gage from Dwyer Instruments Inc.

In an embodiment, the system 400 further comprises a second flow meter 456. The second flow meter 456 may be fluidly connected to pipe 454. The second flow meter 456 measures the flow rate of the discharge waste.

The second flow meter 456 may be any suitable flow meter. Suitable second flow meters include, but are not limited to, magnetic, paddlewheel, ultrasonic vortex and insertion-type vortex flow meters. For example, a suitable second flow meter 456 is available from Mettler-Toledo Thornton, Inc. In an embodiment, the second flow meter 456 may be a Model 8030 from Mettler-Toledo Thornton, Inc. electrically connected to a Multiparameter Transmitter M400 from Mettler-Toledo AG.

### Optional Limit/Level Switches

In an embodiment, the system 400 further comprises a high-water level switch (not shown) and/or a low-water level switch (not shown).

The high-water level and the low-water level switches may be any suitable water level switches. For example, the high-water level and the low-water level switches are available from Magnetrol International Inc. In an embodiment, the high-water level and the low-water level switches are C24, C25 Boiler and Water Column Liquid Level Switches from Magnetrol International Inc.

### Optional Acid Conditioning System

In an embodiment, the system 400 further comprises an acid conditioning system 460. The acid conditioning system 460 comprises an acid tote 462 and an acid metering pump 466.

The acid may be any suitable acid. Suitable acids include, but are not limited to, hydrochloric acid and sulfuric acid. In an embodiment, the acid may be hydrochloric acid (20 baume). In an embodiment, the acid may be sulfuric acid (98%). In an embodiment, the desired pH of the wastewater is about 6.5 or below to minimize calcium carbonate scaling. In an embodiment, the amount of acid solution added varies, depending on inlet water conditions (e.g., pH, alkalinity).

An outlet of the acid tote 462 may be fluidly connected to an inlet of the acid metering pump 466 via tubing 464; and an outlet of the acid metering pump 466 may be fluidly connected to pipe 422 via tubing 472.

The acid tote 462 may be any suitable acid tote or other bulk chemical storage unit. Suitable acid totes include, but are not limited to, an industry standard shipping tote. For example, a suitable acid tote 462 is available from National Tank Outlet. In an embodiment, the acid tote 462 may be a 275 gallon or a 330 gallon industry standard shipping tote.

The acid metering pump 466 may be any suitable acid metering pump. Suitable acid metering pumps include, but are not limited to, peristaltic pumps. For example, a suitable acid metering pump 466 is available from Blue-White Industries, Inc., Cole Palmer Instrument Company and Watson Marlow. In an embodiment, the acid metering pump 466 may be a self-priming peristaltic pump from Blue-White Industries, Inc.

The tubing 464, 472 may be made of any suitable corrosion-resistant tubing. The tubing 464, 472 may be made of any suitable corrosion-resistant metals or plastics. Suitable metals include, but are not limited to, AL-6XN alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. For example, suitable tubing 464, 472 may be made of Teflon® PFA or PTFE.

In an embodiment, the acid conditioning system 460 further comprises an acid flow meter 470. The acid flow meter 470 may be fluidly connected to tubing 472. The acid flow meter 470 measures the flow rate of the acid solution.

The acid flow meter 470 may be any suitable flow meter. Suitable acid flow meters include, but are not limited to, paddlewheel, ultrasonic vortex and insertion-type vortex flow meters. For example, a suitable acid flow meter 470 is available from ProMinent. In an embodiment, the acid flow meter 470 may be a Model DulcoFlow DFMa from ProMinent with built-in signal transmission capability.

### Optional Bactericide Conditioning System

In an embodiment, the system 400 further comprises a bactericide conditioning system 474. The bactericide conditioning system 474 comprises a bactericide tote 476 and a bactericide metering pump 480.

The bactericide may be any suitable bactericide. Suitable bactericide includes, but is not limited to, bleach, bromine, chlorine dioxide (generated), 2,2-dibromo-3-nitrilo-propionade (DBNPA), glutaraldehyde, isothiazolin (1.5%) and ozone (generated). In an embodiment, the bactericide may be selected from the group consisting of bleach (12.5%), bromine, chlorine dioxide (generated), DBNPA (20%), glutaraldehyde (50%), isothiazolin (1.5%) and ozone (generated). In an embodiment, the desired bactericide concentration is from about 10 ppm to about 1000 ppm (and any range or value there between). The amount of bactericide solution added to the wastewater varies, depending on inlet water condition.

An outlet of the bactericide tote 476 may be fluidly connected to an inlet of the bactericide metering pump 480 via tubing 478; and an outlet of the bactericide metering pump 480 may be fluidly connected to pipe 422 via tubing 482.

The bactericide tote 476 may be any suitable bactericide tote or other bulk chemical storage unit. Suitable bactericide totes include, but are not limited to, an industry standard shipping tote. For example, a suitable bactericide tote 476 is available from National Tank Outlet. In an embodiment, the bactericide tote 476 may be a 275 gallon or 330 gallon industry standard shipping tote.

In an alternative embodiment, the bactericide tote 476 may be replaced with a suitable bactericide generating apparatus (not shown). For example, a suitable bactericide apparatus is available from Miox Corporation. In an embodiment, the bactericide generating apparatus (not shown) may be a Model AE-8 from Miox Corporation.

The bactericide metering pump 480 may be any suitable bactericide metering pump. Suitable bactericide metering pumps include, but are not limited to, peristaltic pumps. For example, a suitable bactericide metering pump 480 is available from Blue-White Industries, Inc., Cole-Palmer Instrument Company and Watson Marlow. In an embodiment, the bactericide metering pump 480 may be a self-priming peristaltic pump from Blue-White Industries, Inc.

The tubing 478, 482 may be made of any suitable corrosion-resistant tubing. The tubing 478, 482 may be any suitable metal or plastic. Suitable metals include, but are not limited to, AL-6XN alloy, Hastelloy® alloy, Monel® alloy and combinations thereof; and suitable plastics include, but are not limited to, chlorinated polyvinyl chloride (CPVC) polymers, fiberglass reinforced plastic (FRP), Kynar® polyvinylidene fluoride (PVDF) polymers, polyethylene polymers, polypropylene polymers, polyvinyl chloride (PVC) polymers, Teflon® perfluoroalkoxy (PFA) polymers, Teflon® polytetrafluroethylene (PTFE) polymers, and combinations thereof. In an embodiment, the tubing 478, 482 may be made of Teflon® PFA or PTFE.

In an embodiment, the bactericide conditioning system 474 further comprises a bactericide flow meter 484. The bactericide flow meter 484 may be fluidly connected to tubing 482. The bactericide flow meter 484 measures the flow rate of the bactericide solution.

The bactericide flow meter 484 may be any suitable flow meter. Suitable bactericide flow meters include, but are not limited to, paddlewheel, ultrasonic vortex and insertion-type vortex flow meters. For example, a suitable bactericide flow meter 484 is available from ProMinent. In an embodiment, the bactericide flow meter 484 may be a Model DulcoFlow DFMa from ProMinent with built-in signal transmission capability.

### Programmable Logic Controller or Other Computing Device for System for Spray Evaporation of Water

In an embodiment, the system 100, 400 further comprises a programmable logic controller (PLC) or other computing device 600. The PLC or computing device 600 may be any suitable PLC or other computing device. For example, a suitable PLC or other computing device 600 may be an Allan Bradley, Automation Direct, Seimens, or WAGO logic controllers. Alternatively, the PLC or other computing device 600 may be an engineered circuit board.

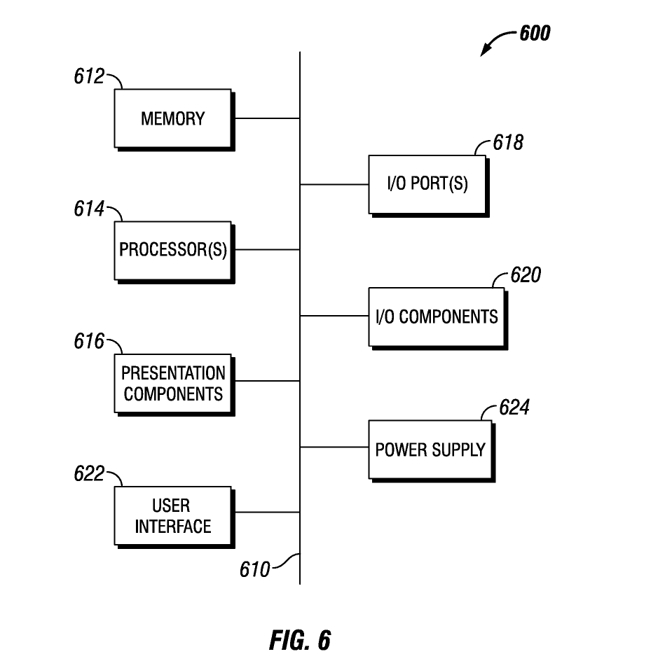

With reference to FIG. 6, the PLC or computing device 600 of the system 100, 400 may include a bus 610 that directly or indirectly couples the following devices: memory 612, one or more processors 614, one or more presentation components 616, one or more input/output (I/O) ports 618, I/O components 620, a user interface 622 and an illustrative power supply 624, and a battery backup (not shown). In an embodiment, the shut-off valve 106, the first pressure switch 110, a first (feed) valve 112, the first limit switch 113, the second limit switch 114, the first pump 118, the first flow meter 122, the first temperature sensor, 130, the first conductivity meter 131, the second conductivity meter 132 (not shown), the air temperature sensor 140, the air blower 142, the air heater with fan 143, the first high differential pressure switch 147, the second high, high differential pressure switch 148, the first high, high limit switch 149, the low limit switch 150, the high limit switch 151, a second high, high limit switch 152, the second pump 156, the second pressure switch 159, the pH meter 161, the second (recycle) valve 166, the third limit switch 167, the fourth limit switch 168, the third (discharge) valve 169, the fifth limit switch 170, the sixth limit switch 171, the second flow meter 173, the third shut-off valve 174, the acid metering pump 180, the acid flow meter (not shown), the bactericide metering pump 185, the bactericide flow meter (not shown), the scale inhibition metering pump 190, the scale inhibition flow meter (not shown), the defoamer pump 195, and/or the defoamer flow meter (not shown) couple directly or indirectly to a signal conditioning device.

In another embodiment, the shut-off valve 406, the first conductivity meter 410, the first flow meter 412, the hygrometer 414, the first 3-way valve 416, the pump 420, the pressure sensor 425, the second conductivity meter 428, the pH meter 430, the second 3-way valve 432, the air blower 436 (or the plurality of air blowers 436′, 436″), the differential pressure sensor 445, the first temperature sensor 590, the second temperature sensor 592, the high-water level switch (not shown), the low-water level switch (not shown), the second flow meter 456, the acid metering pump 466, the acid flow meter 470, the bactericide metering pump 480 and/or the bactericide flow meter 484 couple directly or indirectly to a signal conditioning device. If the component's raw signal must be processed to provide a suitable signal for an I/O system, that component will couple indirectly to the signal conditioning device.

The bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be fuzzy. For example, one may consider a presentation component such as a display device to be an I/O component. Additionally, many processors have memory. The inventors recognize that such is the nature of the art, and reiterate that the diagram of FIG. 6 is merely illustrative of an exemplary computing device that can be used in connection with one or more embodiments of the present invention. Further, a distinction is not made between such categories as “workstation,” “server,” “laptop,” “mobile device,” etc., as all are contemplated within the scope of FIG. 6 and reference to “computing device.”

The PLC or computing device 600 of the system 100, 400 typically includes a variety of computer-readable media. Computer-readable media can be any available media that can be accessed by the PLC or computing device 600 and includes both volatile and nonvolatile media, removable and non-removable media. By way of example, and not limitation, computer-readable media may comprise computer-storage media and communication media. By way of another example, and not limitation, computer readable media may also comprise radio, cellular, or satellite communication media for remote collection and/or manipulation of data contained within the PLC or computing device 600. The computer-storage media includes volatile and nonvolatile, removable and non-removable media implemented in any method or technology for storage of information such as computer-readable instructions, data structures, program modules or other data. Computer-storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the PLC or computing device 600.

The memory 612 includes computer-storage media in the form of volatile and/or nonvolatile memory. The memory 612 may be removable, non-removable, or a combination thereof. Suitable hardware devices include solid-state memory, hard drives, optical-disc drives, etc. The PLC or computing device 600 includes one or more processors 614 that read data from various entities such as the memory 612 or the I/O components 620.

The presentation component(s) 616 present data indications to a user or other device. In an embodiment, the PLC or computing device 600 outputs present data indications including conductivity(ies), differential pressure(s), flow rate(s), humidity, pH, pressure, temperature and/or the like to a presentation component 616. Suitable presentation components 616 include a display device, speaker, printing component, vibrating component, and the like.

The user interface 622 allows the user to input/output information to/from the PLC or computing device 600. Suitable user interfaces 622 include keyboards, key pads, touch pads, graphical touch screens, and the like. In some embodiments, the user interface 622 may be combined with the presentation component 616, such as a display and a graphical touch screen. In some embodiments, the user interface 622 may be a portable hand-held device. The use of such devices is well-known in the art.

In an embodiment, the one or more I/O ports 618 allow the PLC or computing device 600 to be logically coupled to other devices including the shut-off valve 106, the first pressure switch 110, a first (feed) valve 112, the first limit switch 113, the second limit switch 114, the first pump 118, the first flow meter 122, the first temperature sensor, 130, the first conductivity meter 131, the second conductivity meter 132 (not shown), the air temperature sensor 140, the air blower 142, the air heater with fan 143, the first high differential pressure switch 147, the second high, high differential pressure switch 148, the first high, high limit switch 149, the low limit switch 150, the high limit switch 151, a second high, high limit switch 152, the second pump 156, the second pressure switch 159, the pH meter 161, the second (recycle) valve 166, the third limit switch 167, the fourth limit switch 168, the third (discharge) valve 169, the fifth limit switch 170, the sixth limit switch 171, the second flow meter 173, the third shut-off valve 174, the acid metering pump 180, the acid flow meter (not shown), the bactericide metering pump 185, the bactericide flow meter (not shown), the scale inhibition metering pump 190, the scale inhibition flow meter (not shown), the defoamer pump 195, and/or the defoamer flow meter (not shown), and other I/O components 620, some of which may be built in.

In another embodiment, the one or more I/O ports 618 allow the PLC or computing device 600 to be logically coupled to other devices including the shut-off valve 406, the first conductivity meter 410, the first flow meter 412, the hygrometer 414, the first 3-way valve 416, the pump 420, the pressure sensor 425, the second conductivity meter 428, the pH meter 430, the second 3-way valve 432, the air blower 436 (or the plurality of air blowers 436′, 436″), the differential pressure sensor 445, the first temperature sensor 590, the second temperature sensor 592, the high-water level switch (not shown), the low-water level switch (not shown), the second flow meter 456, the acid metering pump 466, the acid flow meter 470, the bactericide metering pump 480 and/or the bactericide flow meter 484, and other I/O components 620, some of which may be built in. Examples of other I/O components 620 include a printer, scanner, wireless device, and the like.

In an embodiment (see FIGS. 1A-3), the PLC or computing device 600 controls the two-pump system 100 according to the following circumstances:
To initiate the process, the following occurs:
   Initially, an air temperature sensor 140 is set to a predetermined minimum air temperature (e.g., typically from about 25° F. to about 35° F.). If the air temperature sensor 140 is activated, the system 100 will stop operations due to an inability of the air heater with fan 143 to raise the wastewater temperature in the sump (bottom) of the container 139 above the freezing point.
   Initially, the first (feed) valve 112 is in a CLOSED position. To begin processing wastewater, the first (feed) valve 112 is switched to the OPEN position, allowing the feedstock water to enter the first pump 118. In an embodiment, the first limit switch 113 confirms that the first (feed) valve 112 is OPEN; and the second limit switch 114 confirms that the first (feed) valve 112 is CLOSED.
   The first pump 118 is started to fill the sump (bottom) of the container 139 with an initial fill volume of wastewater. To aid the second (recycle) pump 156, the container 139 is set at forward incline to allow maximum depth at the suction-end (front) of the container 139 to provide minimal sump volume. If the first conductivity meter 131 measures a predetermined minimum conductivity (e.g., indicating presence of oil in feedwater), the system 100 is shut off.
   When the high limit switch 151 (at an operational level) is activated, the first (feed) valve 112 is switched to the CLOSED position; and the first pump 118 is shut off. In an embodiment, the second limit switch 114 confirms that the first (feed) valve 112 is CLOSED. If the first high, high limit switch 149 (at a primary containment level) is activated, the first (feed) valve 112 and the second (recycle) valve 166 are switched to the CLOSED positions; and the first pump 118 and the second pump 156 are shut off to prevent overfilling of the sump (bottom) of the container 139. In an embodiment, the second limit switch 114 confirms that the first (feed) valve 112 is CLOSED; and the third limit switch 167 confirms that the second (recycle) valve is CLOSED. If the second high, high limit switch 152 (at a secondary containment level) is activated, an alarm is sent to the PLC or computing device 600. Further, the first (feed) valve 112 and the second (recycle) valve 166 are switched to the CLOSED positions; and the first pump 118 and the second pump 156 are shut off to prevent overfilling of the sump (bottom) of the container 139. In an embodiment, the second limit switch 114 confirms that the first (feed) valve 112 is CLOSED; and the third limit switch 167 confirms that the second (recycle) valve is CLOSED.
   Optionally, acid may be added to the sump (bottom) of the container 139 or to the pipe 154 via the acid conditioning system 177, bactericide may be added to the sump (bottom) of the container 139 or to the pipe 154 via the bactericide conditioning system 182, scale inhibitor may be added to the sump of the container or to the pipe 154 via the scale inhibition system and/or defoamer may be added to the sump (bottom) of the container 139 or to the pipe 154 via the defoamer system 192 based on the initial fill volume.
   The air blower 142 is started. If the first high differential pressure switch 147 is activated, the air blower 142 is operating. If a flame is present in the natural gas burner, the air heater with fan 143 is started.
   Initially, the second (recycle) valve 166 is in a CLOSED position. To allow recirculating wastewater to enter the spray system 134, the second (recycle) valve 166 is switched to the OPEN position. In an embodiment, the third limit switch 167 confirms that the second (recycle) valve 166 is CLOSED; and the fourth limit switch 168 confirms that the second (recycle) valve 166 is OPEN.
   Initially, the third (discharge) valve 169 is in a CLOSED position. In an embodiment, the fifth limit switch 170 confirms that the third (discharge) valve 169 is OPEN; and the sixth limit switch 171 confirms that the third (discharge) valve 169 is CLOSED.
   The second pump 156 is started to recirculate the wastewater from the sump (bottom) of the container 139 through the spray system 134. If the second pressure switch 159 is activated, a minimum pressure has been obtained. If the first conductivity sensor/meter 131 measures a predetermined low conductivity (e.g., indicating presence of oil in recycle wastewater), the system 100 is shut off.
   Optionally, acid may be added to the sump (bottom) of the container 139 or to the pipe 154 via the acid conditioning system 177, bactericide may be added to the sump (bottom) of the container 139 or to the pipe 154 via the bactericide conditioning system 182, scale inhibitor may be added to the sump of the container 139 or to the pipe 154 via the scale inhibition system and/or defoamer may be added to the sump (bottom) of the container 139 or to the pipe 154 via the defoamer system 192 based on wastewater condition as indicated by pH meter 161, the first conductivity meter 131, and/or the second conductivity meter 132 (not shown).
If the low limit switch 150 is activated, the following occurs:
   To continue processing wastewater, the first (feed) valve 112 is switched to the OPEN position, allowing the feedstock water to enter the first pump 118. In an embodiment, the first limit switch 113 confirms that the first (feed) valve 112 is OPEN.
   The first pump 118 is started to fill the sump (bottom) of the container 139 with an initial fill volume of wastewater. If the first conductivity sensor/meter 131 measures a predetermined minimum conductivity (e.g., indicating presence of oil in feedwater), the system 100 is shut off.
   When the high limit switch 151 (at an operational level) is activated, the first (feed) valve 112 is switched to the CLOSED position; and the first pump 118 is shut off. In an embodiment, the second limit switch 114 confirms that the first (feed) valve 112 is CLOSED.
   Optionally, acid may be added to the sump (bottom) of the container 139 or to the pipe 154 via the acid conditioning system 177, bactericide may be added to the sump (bottom) of the container 139 or to the pipe 154 via the bactericide conditioning system 182, scale inhibitor may be added to the sump (bottom) of the container 139 or to the pipe 154 via the scale inhibition system and/or defoamer may be added to the sump (bottom) of the container 139 or to the pipe 154 via the defoamer system 192 based on the initial fill volume.
If the second conductivity meter 132 indicates the brine has reached a predetermined maximum conductivity, the following occurs:
   To begin discharging brine, the third (discharge) valve 169 is switched to the OPEN position, allowing the brine to discharge from the waste outlet 176. In an embodiment, the fifth limit switch 170 confirms that the third (discharge) valve 169 is OPEN.
   To prevent recycle of brine, the second (recycle) valve 166 is switched to the CLOSED position. In an embodiment, the third limit switch 167 confirms that the second (recycle) valve 166 is CLOSED.
   When the second pressure switch 159 indicates a loss of pressure due to nearly complete discharge of brine from the discharge outlet 176, the second pump 156 will begin to lose prime.
   To allow recycle of residual brine, the second (recycle) valve 166 is switched to the OPEN position. In an embodiment, the fourth limit switch 168 confirms that the second (recycle) valve 166 is OPEN.
   To stop discharge of brine, the third (discharge) valve 169 is switched to the CLOSED position. In an embodiment, the fifth limit switch 171 confirms that the third (discharge) valve 169 is CLOSED.
   To continue processing wastewater, the first (feed) valve 112 is switched to the OPEN position, allowing the feedstock water to enter the first pump 118. In an embodiment, the first limit switch 113 confirms that the first (feed) valve 112 is OPEN.
   The first pump 118 is started to fill the sump (bottom) of the container 139 with an initial fill volume of wastewater. If the first conductivity sensor/meter 131 measures a predetermined minimum conductivity (e.g., indicating presence of oil in feedwater), the system 100 is shut off.
   When the high limit switch 151 (at an operational level) is activated, the first (feed) valve 112 is switched to the CLOSED position; and the first pump 118 is shut off. In an embodiment, the second limit switch 114 confirms that the first (feed) valve 112 is CLOSED.
   Optionally, acid may be added to the sump (bottom) of the container 139 or to the pipe 154 via the acid conditioning system 177, bactericide may be added to the sump (bottom) of the container 139 or to the pipe 154 via the bactericide conditioning system 182, scale inhibitor may be added to the sump (bottom) of the container 139 or to the pipe 154 via the scale inhibition system and/or defoamer may be added to the sump (bottom) of the container 139 or to the pipe 154 via the defoamer system 192 based on the initial fill volume.
The system 100 runs continuously until shut off by an operator or by PLC or computing device 600 due to occurrence of one of the above-discussed situations.

In an embodiment, the PLC or computing device 600 monitors hygrometer 414 (e.g., barometric pressure, humidity, temperature) and controls operating conditions of the system 100 to maximize evaporation through the control of droplet size created by the spray system 134 and air volume provided through the air blower and heater system 141, as discussed below.

In an embodiment, the PLC or computing device 600 monitors the pH meter 161 and controls the addition of acid introduced to the water to condition it for the prevention of scale (scaling), as discussed below.

In an embodiment, the PLC or computing device 600 controls the addition of bactericide introduced to the water to condition it for the prevention of microbial (e.g., algae, bacteria) growth, as discussed below.

In an embodiment, the PLC or computing device 600 controls the addition of scale inhibitor introduced to the water to condition it for the prevention of scale (e.g., mineral) build up, as discussed below.

In an embodiment, the PLC or computing device 600 controls the addition of defoamer introduced to the water to condition it for the prevention of foam, as discussed below.

In another embodiment (see FIGS. 4A-5D), the PLC or computing device 600 controls the first three-way valve 416 of the single pump system 400 according to the following circumstances:
If the low-water level switch (not shown) in the container 444 is activated, the first 3-way valve 416 diverts suction of the pump 420 to a water inlet 404, allowing connection to a wastewater suction header 402. The first 3-way valve 416 will remain in this state until a high-water level switch (not shown) in the container 444 is activated.
When the high-water level switch (not shown) in the container 444 is activated, the first 3-way valve 416 diverts suction of the pump 420 to a draw line 452 for the container 444, providing for a recycle of the water in the container 444 through the spray system 440.

Further, the PLC or computing device 600 controls the second 3-way valve 432 on the discharge side of the pump 420 according to the following circumstances:
By default, the second 3-way valve 432 will divert the discharge of water to the spray system 440.
If the conductivity of water in the conductivity meter 428 reaches a predetermined maximum conductivity, the second 3-way valve 432 will divert discharge of the concentrated waste to the waste outlet 458 of the container 444, allowing connection to an external waste disposal storage (e.g., tank, truck or pond) (not shown). The second 3-way valve 432 will remain in this position until the low-water level switch (not shown) in the container 444 is activated. At which point, the second 3-way valve 432 is returned to its default position.

In an embodiment, the PLC or computing device 600 monitors hygrometer 414 (e.g., barometric pressure, humidity, temperature) and controls operating conditions of the system 400 to maximize evaporation through the control of droplet size created by the spray system 440 and air volume provided through the air blower system 434, as discussed below.

In an embodiment, the PLC or computing device 600 monitors the pH meter and controls the addition of acid introduced to the water to condition it for the prevention of scale (e.g., mineral) build up, as discussed below.

In an embodiment, the PLC or computing device 600 controls the addition of bactericide introduced to the water to condition it for the prevention of microbial (e.g., algae, bacteria) growth, as discussed below.

### Method for Using System for Spray Evaporation of Water

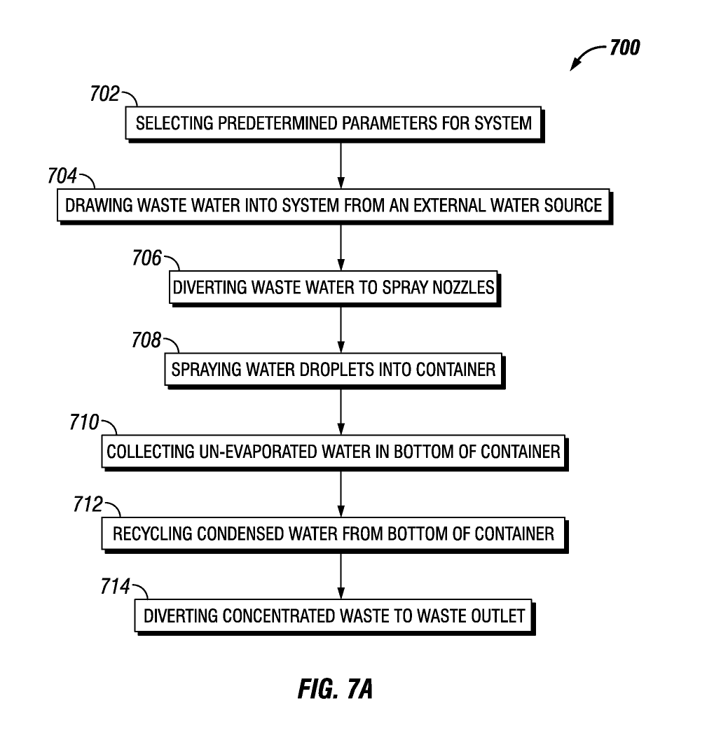

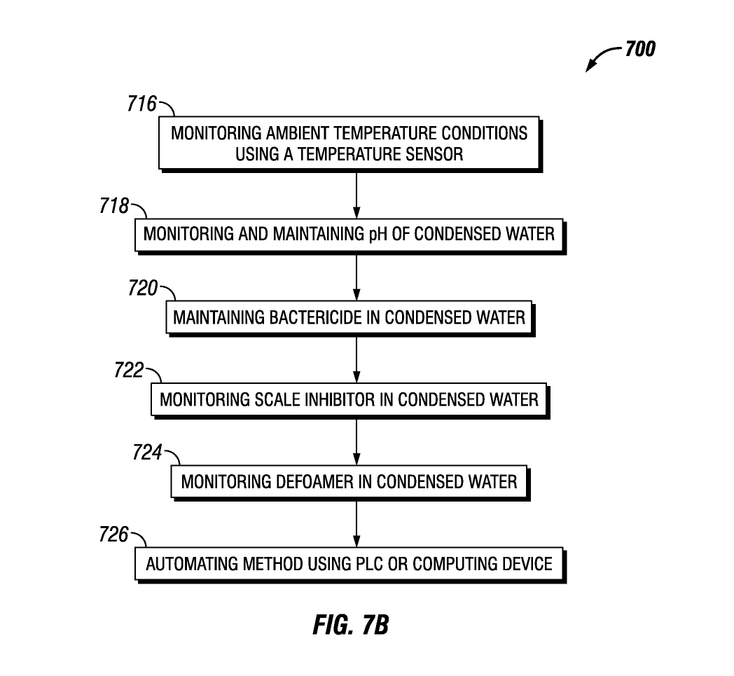

A flow diagram for a method 700 of using a system for spray evaporation of water is shown in FIGS. 7A-7B. In an embodiment, the method 700 comprises selecting predetermined parameters (e.g., air flow rate, air heating rate, maximum conductivity, maximum humidity, maximum pH, minimum air temperature, minimum pH, water flow rate, water droplet size) for a system for spray evaporation of water, drawing wastewater into the system from an external water source using a first pump and a first valve, diverting the wastewater to a spray nozzle, spraying the wastewater through the spray nozzle to create water droplets, spraying the water droplets into a container of the system along with a large volume of air, collecting condensed water in the sump (bottom) of the container, recycling condensed water from the bottom of the container using a second pump and a second valve, and diverting the concentrated waste to a waste outlet using a third valve, as illustrated in FIGS. 7A-7B.

In an embodiment, the method 700 comprises a step 702 of selecting predetermined parameters (e.g., maximum conductivity, water droplet size, air flow rate, air heating rate, water flow rate, maximum humidity) for the system of spray evaporation of water. In an embodiment, the maximum conductivity may be about 1,000 micro μS/cm to about 400,000 μS/cm (and any range or value there between). In an embodiment, the water droplet size may be about 50 μm to about 1,000 μm (and any range or value there between). In an embodiment, the air flow rate may be about 60,000 cubic feet per minute (CFM) to about 150,000 CFM (and any range or value there between). In an embodiment, the air heating rate may be from about 0 million BTU per hour to about 4 million BTU per hour (and any range or value there between). In an embodiment, the water flow rate may be about 50 gallons per minute (GPM) to about 800 GPM (and any range or value there between).

In an embodiment, the method 700 comprises a step 704 of drawing wastewater into the system from an external water source using a first pump and a first valve. In an embodiment, a wastewater inlet permits connection to the external wastewater source. The water inlet may be connected to the external wastewater source via a hose, pipe or other means customary in the art.

In an embodiment, the method 700 comprises a step 706 of diverting inlet wastewater or condensed water to a spray nozzle and spraying the inlet wastewater through the spray nozzle to create water droplets. In an embodiment, the water droplets may be sized to create an optimal surface area for water evaporation, but large enough to minimize passage through the pores of the demister pads.

In an embodiment, the method 700 comprises a step 708 of spraying the water droplets into a container of the system. In an embodiment, the water droplets may be sprayed to a furthest point in the container to lengthen air contact and enhance water evaporation. In an embodiment, air may be blown counter to the sprayed water droplets to increase air contact and improve water evaporation.

In an embodiment, the method 700 comprises a step 710 of collecting condensed water in the sump (bottom) of the container. In an embodiment, un-evaporated water is condensed in a demister element of the system and condensed water is collected in the sump (bottom) of the container.

In an embodiment, the method 700 comprises a step 712 of recycling the condensed water from the sump (bottom) of container using a second pump and a second valve. In an embodiment, when the condensed water reaches a predetermined high-water level, the second pump draws condensed water from the sump (bottom) of the container and the second valve diverts the condensed water to the spray nozzle. In an embodiment, the second pump will continue recirculating the condensed water until the condensed water in the sump (bottom) of the container reaches a predetermined low-water level or a predetermined maximum conductivity as measured by a conductivity meter. In an embodiment, the first pump will draw wastewater into the system from the external water source when the condensed water in the sump (bottom) of the container reaches the predetermined low-water level.

In an embodiment, the method 700 comprises a step 714 of diverting concentrated water to a waste outlet using a third valve. In an embodiment, when the condensed wastewater reaches a predetermined maximum conductivity, the third valve diverts the concentrated waste to the waste outlet. In an embodiment, a waste outlet permits connection to an external waste disposal storage (e.g., tank, truck, pond). The waste outlet may be connected to the external waste disposal storage via a hose, pipe or other means customary in the art.

In an embodiment, the method 700 further comprises a step 716 of monitoring ambient temperature using an air temperature sensor. In an embodiment, when the ambient temperature precludes water evaporation, the system is shut down, as discussed below.

In an embodiment, the method 700 further comprises a step 718 of monitoring pH of the inlet wastewater or condensed water using a pH meter and adding acid solution to the inlet wastewater or condensed water to maintain the pH at about 6.5 or below to minimize calcium carbonate scaling. In an embodiment, the desired pH of the wastewater may be above 6.5 if a scale inhibitor is added to minimize carbonate and non-carbonate scaling.

The acid may be any suitable acid. Suitable acids include, but are not limited to, hydrochloric acid and sulfuric acid. In an embodiment, the acid may be hydrochloric acid (20 baume). In an embodiment, the acid may be sulfuric acid (98%). In an embodiment, the desired pH of the wastewater is about 6.5 or below to minimize carbonate scaling. In an embodiment, the desired pH of the wastewater may be above 6.5 if a scale inhibitor is added to minimize carbonate and non-carbonate scaling. In an embodiment, the amount of acid solution added to the wastewater varies, depending on inlet water conditions (e.g., pH).

In an embodiment, the method 700 further comprises the step 720 of maintaining bactericide in inlet wastewater or condensed water. In an embodiment, a predetermined amount of bactericide solution may be added to the inlet wastewater or condensed water to prevent microbial growth.

The bactericide may be any suitable bactericide. Suitable bactericide includes, but is not limited to, bleach, bromine, chlorine dioxide (generated), 2,2-dibromo-3-nitrilo-propionade (DBNPA), glutaraldehyde, isothiazolin (1.5%) and ozone (generated). In an embodiment, the bactericide may be selected from the group consisting of bleach (12.5%), bromine, chlorine dioxide (generated), DBNPA (20%), glutaraldehyde (50%), isothiazolin (1.5%) and ozone (generated). In an embodiment, the desired bactericide concentration is from about 10 ppm to about 1000 ppm (and any range or value there between). The amount of bactericide solution added to the wastewater varies, depending on inlet water condition.

In an embodiment, the method 700 further comprises the step 722 of maintaining scale inhibitor in the inlet wastewater or condensed water. In an embodiment, a predetermined amount of scale inhibitor solution may be added to the inlet wastewater or condensed water to prevent scale growth.

The scale inhibitor may be any suitable scale inhibitor or blend of scale inhibitors. Suitable scale inhibitor includes, but is not limited to, inorganic phosphates, organophosphorous compounds and organic polymers. In an embodiment, the scale inhibitor may be selected from the group consisting of organic phosphate esters, polyacrylates, phosphonates, polyacrylamides, polycarboxylic acids, polymalates, polyphosphincocarboxylates, polyphosphates and polyvinylsylphonates. In an embodiment, the desired scale inhibitor concentration is from about 10 ppm to about 100 ppm (and any range or value there between). In an embodiment, the desired scale inhibitor concentration is from about 2 ppm to about 20 ppm (and any range or value there between). The amount of scale inhibitor solution added to the wastewater varies, depending on inlet water conditions.

In an embodiment, the method 700 further comprises the step 724 of maintaining defoamer in the inlet water or condensed water. In an embodiment, a predetermined amount of defoamer solution may be added to the inlet wastewater or condensed water to prevent foam.

The defoamer may be any suitable defoamer. Suitable defoamer includes, but is not limited to, alcohols, glycols, insoluble oils, silicone polymers and stearates. In an embodiment, the defoamer may be selected from the group consisting of fatty alcohols, fatty acid esters, fluorosilicones, polyethylene glycol, polypropylene glycol, silicone glycols and polydimethylsiloxane. In an embodiment, the desired defoamer concentration is from about 10 ppm to about 100 ppm (and any range or value there between). In an embodiment, the desired defoamer concentration is from about 2 ppm to about 20 ppm (and any range or value there between). The amount of defoamer solution added to the wastewater varies, depending on inlet water conditions.

In an embodiment, the method 700 further comprises a step of 726 of automating the method 700 using a programmable logic controller (PLC) or computing device. In an embodiment, predetermined parameters (e.g., air flow rate, air heating rate, maximum conductivity, maximum humidity, maximum pH, minimum air temperature, minimum pH, water flow rate, water droplet size) are input into the PLC or computing device.

In an embodiment, when ambient air temperature is above a predetermined minimum air temperature, the PLC or computing device controls the system in an “External Source” mode according to the following circumstances:
A first valve diverts suction of a first pump to a water inlet, directing discharge of wastewater to a spray nozzle.
The first pump and the air blower and heater system are running.
The spray nozzles disperse the wastewater into water droplets into a container.
Any un-evaporated water droplets are retained by the pores of a demister element(s) and fall to the bottom of the container via gravity.

In an embodiment, the PLC or computing device will monitor pH of the inlet wastewater or condensed water via a pH meter and automatically add acid solution to the pump discharge using an acid metering pump in an acid conditioning system to maintain the pH at about 6.5 pH or below to minimize calcium carbonate scaling. In an embodiment, the PLC or computing device may add an amount of acid solution to the pump discharge using the acid metering pump and an acid flow meter.

In an embodiment, when condensed water in the sump (bottom) of the container reaches a predetermined high-water level, the PLC or computing device controls the system in a “Recycle” mode:
The first valve diverts suction of the second pump to a draw line connected to the bottom of the container.
The second valve diverts discharge of the condensed water to the spray nozzles.
The second pump and the air blower and heater system continue to run.
The condensed water will be sprayed by the spray nozzles into the container.
Any un-evaporated water droplets are retained by the pores of the demister element(s) and fall to the sump (bottom) of the container via gravity.
   The PLC or computing device continues to operate the system in a “Recycle” mode until the condensed water level in the sump (bottom) of the container is at or below a low-water level switch or until the condensed water reaches a predetermined maximum conductivity.

In an embodiment, the PLC or computing device will monitor pH of the inlet wastewater or condensed water via a pH meter and automatically add acid solution to the pump discharge using an acid metering pump in an acid conditioning system to maintain the pH at about 6.5 pH or below to minimize calcium carbonate scaling. In an embodiment, the desired pH of the wastewater may be above 6.5 if a scale inhibitor is added to minimize carbonate and non-carbonate scaling.

In an embodiment, the PLC or computing device will monitor conductivity of the inlet wastewater or condensed water using a conductivity meter.

In an embodiment, when the condensed water reaches a predetermined maximum conductivity, the PLC or computing device controls the system in a “Waste Discharge” mode according to the following circumstances:
The first valve continues to divert suction of the second pump to a draw line connected to the bottom of the container.
The third valve diverts discharge of the concentrated waste to a waste outlet.
The second pump continues to run; however, the air blower and heater system, and the acid pump are shut off.
Neither conductivity nor pH is being monitored.
   The PLC or other computing device continues to operate the system in a “Discharge” mode until the water level in the sump (bottom) of the container is at or below a low-water level switch. At that point, the PLC or other computing device reverts to operate the system in an “External Source” mode, and proceeds as described above.

In an embodiment, when ambient air temperature reaches a predetermined minimum air temperature, the PLC or computing device controls the system in a “Suspend” mode according to the following circumstances:
The pump(s) and air blower and heater system are shut off.
The first valve diverts suction of the second pump to a draw line connected to the sump (bottom) of the container.
The second valve diverts discharge of wastewater to the spray nozzles.

In an embodiment, when ambient air temperature reaches a level above the predetermined minimum level, the PLC or computing device reverts to operate the system in the “External Source” mode, and proceeds as described above.

### Method of Using System for Spray Evaporation of Water Illustrating Alternative Embodiments

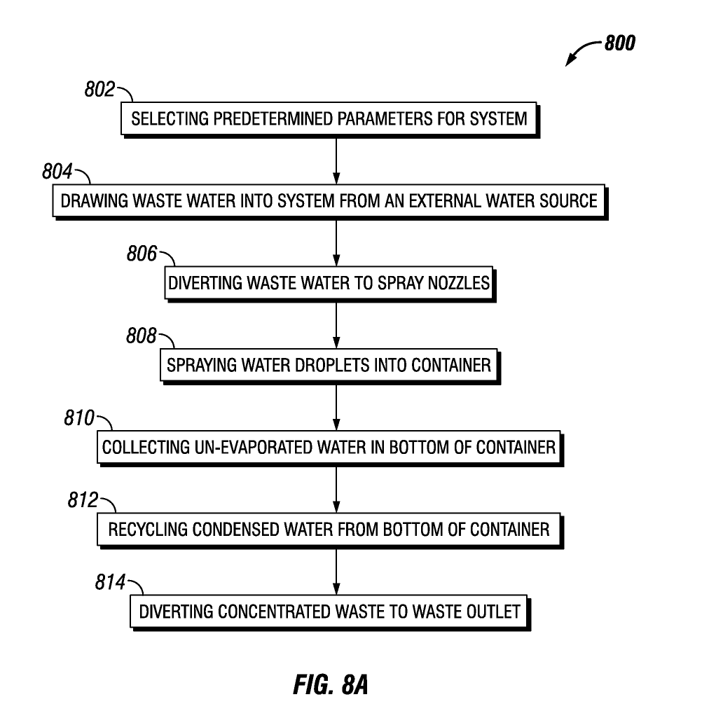

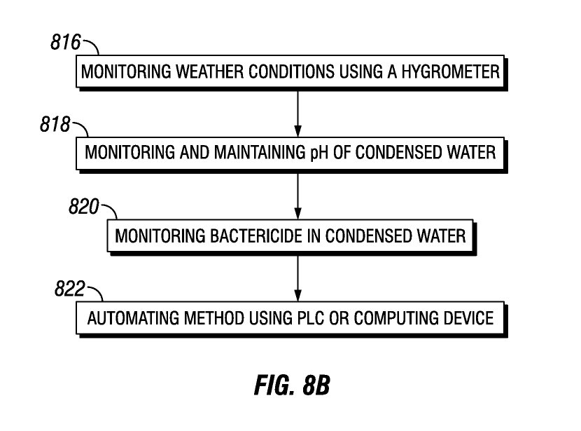

A flow diagram for a method 800 of using an alternative system for spray evaporation of water is shown in FIGS. 8A-8B. In an embodiment, the method 800 comprises selecting predetermined parameters (e.g., air flow rate, air heating rate, maximum conductivity, maximum humidity, maximum pH, minimum air temperature, minimum pH, water flow rate, water droplet size) for a system for spray evaporation of water, drawing wastewater into the system from an external water source using a pump, diverting the wastewater to a spray nozzle, spraying the wastewater through the spray nozzle to create water droplets, blowing the water droplets and air into a container of the system using an air blower, collecting condensed water in the sump (bottom) of the container, recycling condensed water from the bottom of the container using the pump, and diverting the concentrated waste to a waste outlet, as illustrated in FIGS. 8A-8B.

In an embodiment, the method 800 comprises a step 802 of selecting predetermined parameters (e.g., maximum conductivity, water droplet size, air flow rate, air heating rate, water flow rate, maximum humidity) for the system of spray evaporation of water. In an embodiment, the maximum conductivity may be about 1,000 micro μS/cm to about 400,000 μS/cm (and any range or value there between). In an embodiment, the water droplet size may be about 50 μm to about 1,000 μm (and any range or value there between). In an embodiment, the air flow rate may be about 60,000 cubic feet per minute (CFM) to about 150,000 CFM (and any range or value there between). In an embodiment, the water flow rate may be about 50 gallons per minute (GPM) to about 800 GPM (and any range or value there between). In an embodiment, the water flow rate may be about 15 GPM to about 100 GPM (and any range or value there between).

In an embodiment, the method 800 comprises a step 804 of drawing wastewater into the system from an external water source using a pump. In an embodiment, a wastewater inlet permits connection to the external wastewater source. The water inlet may be connected to the external wastewater source via a hose, pipe or other means customary in the art.

In an embodiment, the method 800 comprises a step 806 of diverting inlet wastewater or condensed water to a spray nozzle using a 3-way valve and spraying the inlet wastewater or condensed water through the spray nozzle to create water droplets. In an embodiment, the water droplets may be sized to create an optimal surface area for water evaporation.

In an embodiment, the method 800 comprises a step 808 of blowing the water droplets and air into a container of the system. In an embodiment, the water droplets and air may be blown to a furthest point in the container to lengthen air contact and enhance water evaporation.

In an embodiment, the method 800 comprises a step 810 of collecting condensed water in the sump (bottom) of the container. In an embodiment, un-evaporated water is condensed in a demister element of the system and condensed water is collected in the sump (bottom) of the container.

In an embodiment, the method 800 comprises a step 812 of recycling the condensed water from the sump (bottom) of the container using the pump. In an embodiment, when the condensed water reaches a predetermined high-water level, the pump draws condensed water from the sump (bottom) of the container instead of drawing wastewater into the system from the external water source. In an embodiment, the pump will continue recirculating the condensed water until the condensed water in the sump (bottom) of the container reaches a predetermined low-water level or a predetermined maximum conductivity as measured by a conductivity meter. In an embodiment, the pump will draw wastewater into the system from the external water when the condensed water in the sump (bottom) of the container reaches the predetermined low-water level.

In an embodiment, the method 800 comprises a step 814 of diverting concentrated water to a waste outlet using a 3-way valve. In an embodiment, when the condensed wastewater reaches a predetermined maximum conductivity, a 3-way valve diverts the concentrated waste to the waste outlet. In an embodiment, a waste outlet permits connection to an external waste disposal storage (e.g., tank, truck, pond). The waste outlet may be connected to the external waste disposal storage via a hose, pipe or other means customary in the art.

In an embodiment, the method 800 further comprises a step 816 of monitoring weather conditions using a hygrometer. In an embodiment, when the weather conditions (e.g., barometric pressure, humidity, temperature) preclude water evaporation, the system is shut down, as discussed below.

In an embodiment, the method 800 further comprises a step 818 of monitoring pH of the inlet wastewater or condensed water using a pH meter and adding acid solution to the inlet wastewater or condensed water to maintain the pH at about 6.5 or below to minimized calcium carbonate scaling. In an embodiment, the desired pH of the wastewater may be above 6.5 if a scale inhibitor is added to minimize carbonate and non-carbonate scaling.

The acid may be any suitable acid. Suitable acids include, but are not limited to, hydrochloric acid and sulfuric acid. In an embodiment, the acid may be hydrochloric acid (20 baume). In an embodiment, the acid may be sulfuric acid (98%). In an embodiment, the desired pH of the wastewater is about 6.5 or below to minimize calcium carbon scaling. In an embodiment, the amount of acid solution added to the wastewater varies, depending on inlet water conditions (e.g., pH, alkalinity).

In an embodiment, the method 800 further comprises the step 820 of adding a predetermined amount of bactericide solution to the inlet wastewater or condensed water to minimize microbial growth.

The bactericide may be any suitable bactericide. Suitable bactericide includes, but is not limited to, bleach, bromine, chlorine dioxide (generated), 2,2-dibromo-3-nitrilo-propionade (DBNPA), glutaraldehyde, isothiazolin (1.5%) and ozone (generated). In an embodiment, the bactericide may be selected from the group consisting of bleach (12.5%), bromine, chlorine dioxide (generated), DBNPA (20%), glutaraldehyde (50%), isothiazolin (1.5%) and ozone (generated). In an embodiment, the desired bactericide concentration is from about 10 ppm to about 1000 ppm (and range or value there between). The amount of bactericide solution added to the wastewater varies, depending on inlet water conditions.

In an embodiment, the method 800 further comprises a step of 822 of automating the method 800 using a programmable logic controller (PLC) or computing device. In an embodiment, predetermined parameters (e.g., air flow rate, air heating rate, maximum conductivity, maximum humidity, maximum pH, minimum air temperature, minimum pH, water flow rate, water droplet size) are input into the PLC or computing device.

In an embodiment, when ambient humidity is below a predetermined maximum humidity, the PLC or computing device controls the system in an “External Source” mode according to the following circumstances:
A first 3-way valve diverts suction of a pump to a water inlet.
A second 3-way valve diverts discharge of wastewater to a spray nozzle.
The pump and air blower are running.
The spray nozzles atomize the wastewater into water droplets and the air blower blows the water droplets and air into a container.
Any un-evaporated water droplets are retained by the pores of a demister element(s) and fall to the bottom of the container via gravity.

In an embodiment, the PLC or computing device will monitor pH of the inlet wastewater or condensed water via a pH meter and automatically add acid solution to the pump discharge using an acid metering pump in an acid conditioning system to maintain the pH at about 6.5 pH or below to minimize calcium carbonate scaling. In an embodiment, the PLC or computing device may add an amount of acid solution to the pump discharge using the acid metering pump and an acid flow meter.

In an embodiment, when condensed water in the sump (bottom) of the container reaches a predetermined high-water level, the PLC or computing device controls the system in a “Recycle” mode:
The first 3-way valve diverts suction of the pump to a draw line connected to the bottom of the container.
The second 3-way valve continues to divert discharge of condensed water to the spray nozzles.
The pump and air blower continue to run.
The condensed water will be atomized by the spray nozzles and blown by the air blower from the front to the back of the container according to the predetermined parameters (e.g., water droplet size, air flow rate).
Any un-evaporated water droplets are retained by the pores of the demister element(s) and fall to the sump (bottom) of the container via gravity.
   The PLC or computing device continues to operate the system in a “Recycle” mode until the condensed water level in the sump (bottom) of the container is at or below a low-water level switch or until the condensed water reaches a predetermined maximum conductivity.

In an embodiment, the PLC or computing device will monitor pH of the inlet wastewater or condensed water via a pH meter and automatically add an acid solution to the pump discharge using an acid metering pump in an acid conditioning system to maintain the pH at about 6.5 pH or below, if required, based on waste water quality.

In an embodiment, the PLC or computing device will monitor conductivity of the inlet wastewater or condensed water using a conductivity meter.

In an embodiment, when the condensed water reaches a predetermined maximum conductivity, the PLC or computing device controls the system in a “Waste Discharge” mode according to the following circumstances:
The first 3-way valve continues to divert suction of the pump to a draw line connected to the bottom of the container.
The second 3-way valve diverts discharge of the concentrated waste to a waste outlet.
The pump continues to run; however, the air blower and the acid pump are shut off.
Neither conductivity nor pH is being monitored.
   The PLC or other computing device continues to operate the system in a “Discharge” mode until the water level in the sump (bottom) of the container is at or below a low-water level switch. At that point, the PLC or other computing device reverts to operate the system in an “External Source” mode, and proceeds as described above.

In an embodiment, when ambient humidity reaches a predetermined maximum humidity, the PLC or computing device controls the system in a “Suspend” mode according to the following circumstances:
The pump(s) and air blower are shut off.
The first 3-way valve diverts suction of the pump to a draw line connected to the sump (bottom) of the container.
The second 3-way valve diverts discharge of wastewater to the spray nozzles.

In an embodiment, when ambient humidity reaches a level below the predetermined maximum level, the PLC or computing device reverts to operate the system in the “External Source” mode, and proceeds as described above.

The embodiments set forth herein are presented to best explain the present invention and its practical application and to thereby enable those skilled in the art to make and utilize the invention. However, those skilled in the art will recognize that the foregoing description has been presented for the purpose of illustration and example only. The description as set forth is not intended to be exhaustive or to limit the invention to the precise form disclosed. Many modifications and variations are possible in light of the above teaching without departing from the spirit and scope of the following claims. The invention is specifically intended to be as broad as the claims below and their equivalents.

### DEFINITIONS

As used herein, the terms “a,” “an,” “the,” and “said” mean one or more, unless the context dictates otherwise.

As used herein, the term “about” means the stated value plus or minus a margin of error or plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject.

As used herein, the term “simultaneously” means occurring at the same time or about the same time, including concurrently.

### INCORPORATION BY REFERENCE

All patents and patent applications, articles, reports, and other documents cited herein are fully incorporated by reference to the extent they are not inconsistent with this invention.

What is claimed is:

1. A system for spray evaporating water comprising:
a. a wastewater inlet;
b. a pump, where an outlet of the wastewater inlet is fluidly connected to an inlet of the pump and wherein an outlet of the pump is fluidly connected to an inlet of a manifold;
c. a spray nozzle, wherein an outlet of the manifold is fluidly connected to an inlet of the spray nozzle;
d. a container, wherein an upper portion of the container is enclosed with a demister element and wherein the outlet of the spray nozzle discharges into the container; and
e. a discharge outlet, wherein a bottom of the container is fluidly connected to the discharge outlet.

2. The system of claim 1, wherein the pump produces a water flow rate into the system from about 15 GPM to about 100 GPM.

3. The system of claim 1, wherein the spray nozzle is selected from the group consisting of plain-orifice nozzles, shaped-orifice nozzles, surface impingement spray nozzles, spiral spray nozzles, and pressure swirl spray nozzles.

4. The system of claim 3, wherein the spray nozzle is a surface impingement spray nozzle, wherein the spray nozzle is capable of from about 3 GPM to about 8 GPM.

5. The system of claim 3, wherein the spray nozzle produces water droplet sizes from about 50 μm to about 1,000 μm.

6. The system of claim 1 further comprising an air blower, wherein air flow from the air blower disperses water droplets from the spray nozzle.

7. The system of claim 6, wherein the air blower produces an air flow rate from about 60,000 CFM to about 150,000 CFM.

8. The system of claim 6, further comprising an air heater, wherein an air flow outlet of the air heater is fluidly connected to an air flow inlet of the air blower.

9. The system of claim 6, further comprising a programmable logic controller (PLC) or other computing device, wherein the PLC or other computing device controls the air flow rate from the air blower.

10. The system of claim 1, further comprising an acid conditioning system, wherein the acid conditioning system adds an acid solution to the wastewater.

11. The system of claim 1, further comprising a bactericide conditioning system, wherein the bactericide conditioning system adds bactericide to the wastewater.

12. The system of claim 1, further comprising a scale inhibition conditioning system, wherein the scale inhibition conditioning system adds scale inhibitor to the wastewater.

13. The system of claim 1, further comprising a defoamer system, wherein the defoamer system adds defoamer to the wastewater.

14. A system for spray evaporating water comprising:
a. a wastewater inlet comprising wastewater;
b. a first valve, wherein an outlet of the wastewater inlet is fluidly connected to an inlet of the first valve;
c. a first pump, wherein an outlet of the first valve is fluidly connected to an inlet of the first pump;
d. a container, wherein an upper portion of the container is enclosed with a demister element and wherein the demister element retains un-evaporated water inside the container;
e. a spray nozzle, wherein an outlet of the first pump is fluidly connected to a first inlet of a manifold, wherein an outlet of the manifold is fluidly connected to an inlet of the spray nozzle, and wherein an outlet of the spray nozzle discharges into the container;
f. a second pump, wherein an outlet of the sump is fluidly connected to an inlet of the second pump;
g. a second valve; wherein an outlet of the second pump is fluidly connected to a second inlet of a manifold and wherein a first outlet of the manifold is fluidly connected to the inlet of the spray nozzle; and
h. a third valve, wherein a second outlet of the manifold is fluidly connected to an inlet of the third valve and wherein an outlet of the third valve is fluidly connected to a discharge outlet.

15. The system of claim 14, wherein the first pump produces a water flow rate into the system from about 50 GPM to about 100 GPM, and wherein the second pump produces a water flow rate from about 500 GPM to about 800 GPM.

16. The system of claim 14, wherein the spray nozzle is selected from the group consisting of plain-orifice nozzles, shaped-orifice nozzles, surface impingement spray nozzles, spiral spray nozzles, and pressure swirl spray nozzles.

17. The system of claim 14, wherein the spray nozzle is a spiral spray nozzle, wherein the spiral spray nozzle is capable of from about 50 GPM to about 70 GPM.

18. The system of claim 14, wherein the spray nozzle produces water droplet sizes from about 50 μm to about 1,000 μm.

19. The system of claim 14 further comprising an air blower, wherein air flow from the air blower disperses water droplets from the spray nozzle.

20. The system of claim 19, wherein the air blower produces an air flow rate from about 60,000 CFM to about 150,000 CFM.

21. The system of claim 19, further comprising an air heater, wherein an air flow outlet of the air heater is fluidly connected to an air flow inlet of the air blower.

22. The system of claim 14, further comprising a programmable logic controller (PLC) or other computing device, wherein the PLC or other computing device controls the air flow rate from the air blower.

23. The system of claim 14, further comprising an acid conditioning system, wherein the acid conditioning system adds an acid solution to the wastewater.

24. The system of claim 14, further comprising a bactericide conditioning system, wherein the bactericide conditioning system adds bactericide to the wastewater.

25. The system of claim 14, further comprising a scale inhibition conditioning system, wherein the scale inhibition conditioning system adds scale inhibitor to the wastewater.

26. The system of claim 14, further comprising a defoamer system, wherein the defoamer system adds defoamer to the wastewater.

27. A method for spray evaporating water comprising:
a. selecting predetermined parameters for a system for spray evaporating water;
b. drawing wastewater into the system from an external water source using a pump;
c. diverting wastewater to a spray nozzle;
d. spraying the wastewater through the spray nozzle to create water droplets;
e. dispersing the water droplets into a container of the system;
f. collecting condensed water in the sump of the container;
g. recycling the condensed water from the sump of the container, and
h. diverting concentrated waste to a waste outlet.

28. The method of claim 27, further comprises monitoring conductivity of condensed water using a conductivity meter.

29. The method of claim 28, wherein the predetermined parameters comprise air flow rate, air heating rate, maximum conductivity, and water flow rate, and wherein the concentrated water is discharged to the waste outlet when conductivity of the condensed water reaches the maximum conductivity.

30. The method of claim 29, wherein the water flow rate into the system is from about 50 GPM to about 100 GPM, and wherein the water flow rate recycling in or discharging from the system is from about 500 GPM to about 800 GPM.

31. The method of claim 29, wherein the air flow rate is from about 60,000 CFM to about 150,000 CFM.

32. The method of claim 29, wherein the water droplet size is from 50 μm to about 1,000 μm.

33. The method of claim 27, further comprising monitoring ambient air temperature using a temperature sensor, wherein the predetermined parameters further comprise minimum air temperature.

34. The method of claim 33, wherein the system is shut down when the ambient air temperature reaches the minimum air temperature.

35. The method of claim 27, further comprising monitoring the pH of the condensed water using a pH meter and adding acid solution to the condensed water to maintain the pH at about 6.5 or below.

36. The method of claim 27, further comprising adding bactericide to the condensed water.

37. The method of claim 27, further comprising adding scale inhibitor to the condensed water.

38. The method of claim 27, further comprising adding defoamer to the condensed water.

39. The method of claim 37, further comprising monitoring the pH of the condensed water using a pH meter and adding acid solution to the condensed water to maintain the pH at about 6.5 or below.

40. The system of claim 27, further comprising using a programmable logic controller or other computing device to control the system.
